(19) United States
(12) Patent Application Publication
(10) Pub. No.: US 2026/0080883 A1
(43) Pub. Date: Mar. 19, 2026

(54) Scalar quantization for audio coding

(71) Applicant: Fraunhofer-Gesellschaft zur Förderung der angewandten Forschung e.V., München (DE)

(72) Inventors: Andreas BRENDEL, Erlangen (DE); Nicola PIA, Erlangen (DE); Guillaume FUCHS, Erlangen (DE); Kishan GUPTA, Erlangen (DE); Markus MULTRUS, Erlangen (DE)

(73) Assignee: Fraunhofer-Gesellschaft zur Förderung der angewandten Forschung e.V., München (DE)

(21) Appl. No.: 19/402,974

(22) Filed: Nov. 26, 2025

Related U.S. Application Data
(63) Continuation of application No. PCT/EP2023/064613, filed on May 31, 2023.

(51) Int. Cl. G10L 19/035; G10L 19/00; G10L 19/008

(52) U.S. Cl. CPC G10L 19/035; G10L 19/008; G10L 2019/0002

(57) ABSTRACT

There are described techniques for encoding and decoding audio signals. A decoder, configured to generate an audio signal from a coded signal representing the audio signal, may include: a coded signal reader, configured to read the coded signal, thereby providing a plurality of indexes; a scalar dequantization module, including: a plurality of quantization index converters, each quantization index converter being configured to convert an index of the plurality of indexes onto a corresponding latent scalar value, so that a plurality of latent scalar values form a first latent audio signal representation of the audio signal; and a first learnable section to provide a second latent representation from the first latent audio signal representation; a second learnable section including at least one learnable layer and configured to generate the audio signal from the second latent audio signal representation.

### CROSS-REFERENCE TO RELATED APPLICATIONS

This application is a continuation of copending International Application No. PCT/EP2023/064613, filed May 31, 2023, which is incorporated herein by reference in its entirety.

### TECHNICAL FIELD

There are here disclosed encoders and decoders. For example, there are disclosed vocoders and methods related thereto.

### BACKGROUND OF THE INVENTION

Learning an (intermediate) discrete representation for an audio signal that can be used for efficient signal transmission in communication applications is the core of any Neural Audio Coder (NAC). The present application proposes an efficient model, also called Scalar Quantizer (SQ), for such a discrete representation and associated training techniques that allow for trading off quality against required transmission data rate. The quantization method maps the features outputted by the NAC encoder to a set of representative values yielding a discrete representation of the input signal. The model may include a (e.g. convolutive) encoder-decoder pair that learns a low-dimensional representation of the NAC output, which is quantized channel-wise and potentially transformed for the subsequent decoding by the NAC decoder. The SQ can be trained end-to-end together with the NAC by approximating the non-differentiable quantizer with an identity and an associated MSE loss or by simulating the quantization process by adding uniformly distributed noise. The adjustment of coding levels and latent dimensions by transfer learning using a previously trained NAC allows for rate scalability without the need of (costly) retraining the NAC and storing the resulting weights for each target data rate.

The proposed method shows advantages with regard to interpretability of the discrete representations, computationally efficiency and scalability of data rate without showing severe drawbacks relative to competing conventional methods.

### Context and Related Methods

NACs attracted a lot of research interest from both industry [1, 2] (Soundstream, Encodec) and academia [4] due to the very good quality of the reconstructed audio signals that can be achieved at low required data rates. An integral part of these NACs is a learned, data-efficient, and discrete representation of the input signal, which forms the basis of the transmitted signal. Most NACs consist of a convolutive encoder which provides a compact signal representation to a quantizer module, also called latent. From this signal representation, the transmission signal is formed, which is then reconstructed on receiver side by the NAC decoder.

Most of the conventional NACs leverage variants of vector quantizers (VQs) [5-7] for learning the mentioned discrete intermediate representation. Here, a set of template vectors is learned or chosen appropriately such that they represent the latent as precisely as possible. For each incoming signal frame, the most accurate codebook vector is chosen as a surrogate of the frame-wise latent vector and the corresponding codebook vector index is transmitted. On the receiver side, the NAC decoder reconstructs the input signal based on the representation provided by the chosen codebook vector.

A disadvantage for training such a VQ by backpropagation is its non-differentiability. Therefore, many approaches have been proposed to address this problem including
skipping the quantizer in the backward path and enforcing the codebook structure in the latent by an additional loss (VQ-VAE) [6].
approximating the quantizer by a smooth surrogate (Softmax) [7].
sampling from a continuous relaxation of a discrete distribution (Gumbel Softmax) [8].
soft-to-hard schedules, which deform a smooth surrogate towards a hard quantization during training [7].

While only weakly recognized in neural audio coding (e.g., [3]), scalar quantization approaches are quite popular in neural image and video coding [8]. In this application, we propose a method for learning discrete audio representations based on scalar quantization.

### Drawbacks of Conventional Approaches

There are drawbacks associated with the mentioned conventional approaches:
1. For learning a useful discrete representation of the latent, the codebook vectors of the VQ must be chosen to be large in dimension. This increases the required number of parameters as well as the computational complexity of the resulting NACs substantially.
2. The discrete representation learned by a VQ is often not easy to interpret and shows unintuitive behavior due to the computation of distances between large-dimensional vectors.
3. It is difficult to trade off data rate against quality without retraining the NAC and storing different weights for each trained model.
4. Skipping the quantizer in backpropagation (VQ-VAE) often leads to unintuitive results. The training of the codebooks requires additional mechanisms (e.g., training by recursive averaging) which require additional parameterizations which can lead to instability of training if chosen wrong.
5. Several VQ modules, i.e., a residual VQ, must be trained together to obtain convincing results.
6. The obtained quality for NACs using VQs does not scale well with the used data rate.
7. Training the VQ codebooks is not mandatory but crucial for acceptable convergence rate of for the training of the NAC.
8. Choosing the smoothness for a softmax approximation of the quantizer is difficult as a high degree of smoothness gives well-behaved gradients but a bad approximation of the hard quantization and vice versa. Choosing a schedule for the smoothness complicates this even further.
9. The decision for the best fitting codebook vector requires the computation of distances of the high-dimensional latent vector to all codebook vectors, which may be computational expensive.

### SUMMARY

According to an embodiment, a decoder configured to generate an audio signal from a coded signal representing the audio signal may have: a coded signal reader, configured to read the coded signal, thereby providing a plurality of indexes; a scalar dequantization module, including: a plurality of quantization index converters, each quantization index converter being configured to convert an index of the plurality of indexes onto a corresponding latent scalar value, so that a plurality of latent scalar values form a first latent audio signal representation of the audio signal; and a first learnable section to provide a second latent representation from the first latent audio signal representation; and a second learnable section including at least one learnable layer and configured to generate the audio signal from the second latent audio signal representation.

According to another embodiment, an encoder for generating a coded signal in which an input audio signal is encoded may have: a first learnable section including at least one learnable layer to provide a first latent representation of the input audio signal, a scalar quantization module, to quantize the first latent representation, having: a second learnable section to provide, from the first latent representation, a plurality of latent scalar values to be quantized; and a plurality of quantizers, to provide a plurality of indexes, each quantizer being configured to quantize one single latent scalar value to be quantized and to provide, from the one single latent scalar value, an index of the plurality of indexes; and a coded signal writer configured to write the plurality of indexes in the coded signal.

In accordance to an aspect there is provided a decoder, configured to generate an audio signal from a coded signal representing the audio signal, the decoder including:
a coded signal reader, configured to read the coded signal, thereby providing a plurality of indexes;
a scalar dequantization module, including:
   a plurality of quantization index converters, each quantization index converter being configured to convert an index of the plurality of indexes onto a corresponding latent scalar value, so that a plurality of latent scalar values form a first latent audio signal representation of the audio signal; and
   a first learnable section to provide a second latent representation from the first latent audio signal representation;
a second learnable section including at least one learnable layer and configured to generate the audio signal from the second latent audio signal representation.

In accordance to an aspect there is provided an encoder for generating a coded signal in which an input audio signal is encoded, the encoder comprising:
a first learnable section including at least one learnable layer to provide a first latent representation of the input audio signal,
a scalar quantization module, to quantize the first latent representation, comprising:
   a second learnable section to provide, from the first latent representation, a plurality of latent scalar values to be quantized; and
   a plurality of quantizers, to provide a plurality of indexes, each quantizer being configured to quantize one single latent scalar value to be quantized and to provide, from the one single latent scalar value, an index of the plurality of indexes; and
   a coded signal writer configured to write the plurality of indexes in the coded signal.

In accordance to an aspect there is provided a decoding method to generate an audio signal from a coded signal representing the audio signal, the method including:
reading a coded signal, thereby obtaining a plurality of indexes; performing a scalar dequantization, including:
   performing a conversion through a plurality of quantization index converters, each quantization index converter converting an index of the plurality of indexes onto a corresponding latent scalar value, so that a plurality of latent scalar values form a first latent audio signal representation of the audio signal; and
   through a first learnable section, providing a second latent audio signal representation from the first latent audio signal representation; and
through a second learnable section including at least one learnable layer, generating the audio signal from the second latent audio signal representation.

In accordance to an aspect there is provided a method for generating a coded signal in which an input audio signal is encoded, comprising:
through a first learnable section including at least one learnable layer, providing a first latent representation of the input audio signal,
through a scalar quantization module, quantizing the first latent representation, by:
   through a second learnable section, obtaining, from the first latent representation, a plurality of latent scalar values to be quantized; and
   through a plurality of quantizers, obtaining a plurality of indexes, each quantizer of the plurality of quantizers quantizing one single latent scalar value and providing, from the one single latent scalar value, an index of the plurality of indexes; and
   writing the plurality of indexes in the coded signal.

In accordance to an aspect there is provided a non-transitory storage unit storing instructions which, when executed by a computer, cause the computer to perform and/or control to perform an above method.

### BRIEF DESCRIPTION OF THE DRAWINGS

Embodiments of the present invention will be detailed subsequently referring to the appended drawings, in which:

FIGS. 1a, 1b, and 1c show examples of encoders according to examples;

FIGS. 2a, 2b, 2c, 2d, and 2e show examples of operations and mode selections at an encoder;

FIGS. 3a, 3b, and 3c show examples of decoders according to examples;

FIG. 4 shows an example of operation and mode selection at a decoder;

FIGS. 5a, 5b, and 5c show techniques for controlling the mode selections at the encoder;

FIGS. 6a and 6b show techniques for controlling the mode selections at the decoder;

FIG. 7a shows a residual quantizer at the encoder;

FIG. 7b shows a residual quantizer at the decoder;

FIG. 8 shows an example according to the known technology;

FIG. 9 shows an example according to the present technique;

FIGS. 10 and 11 show examples of encoders and decoders (e.g. more detailed versions of optional features of the encoders and decoders of FIGS. 2a-3c); and

FIGS. 12-15 show examples detailed versions of optional features of the decoders of FIGS. 2a-3c.

### DETAILED DESCRIPTION OF THE INVENTION

### Examples

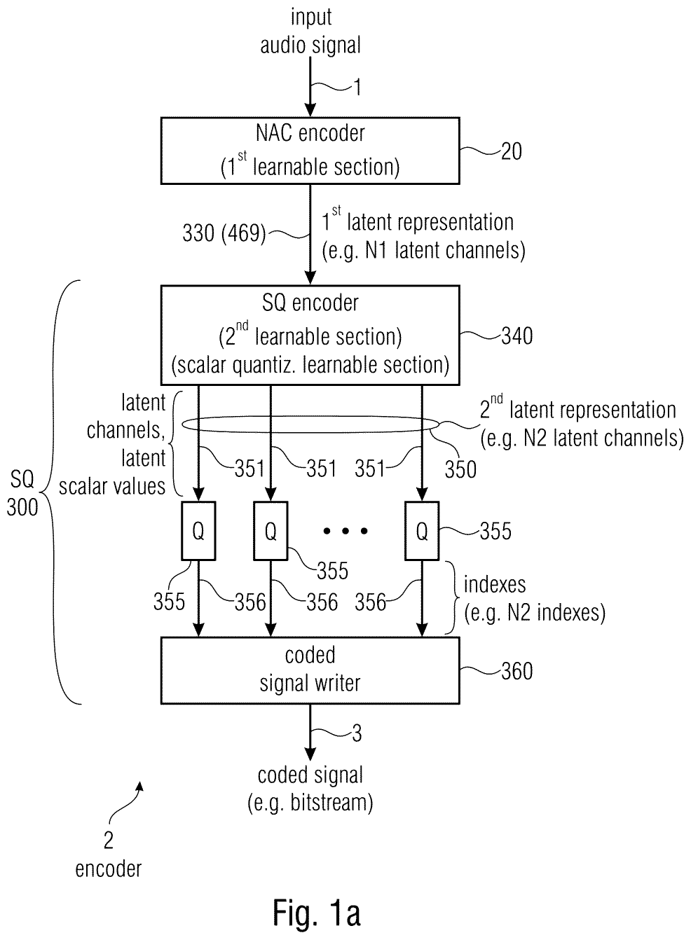

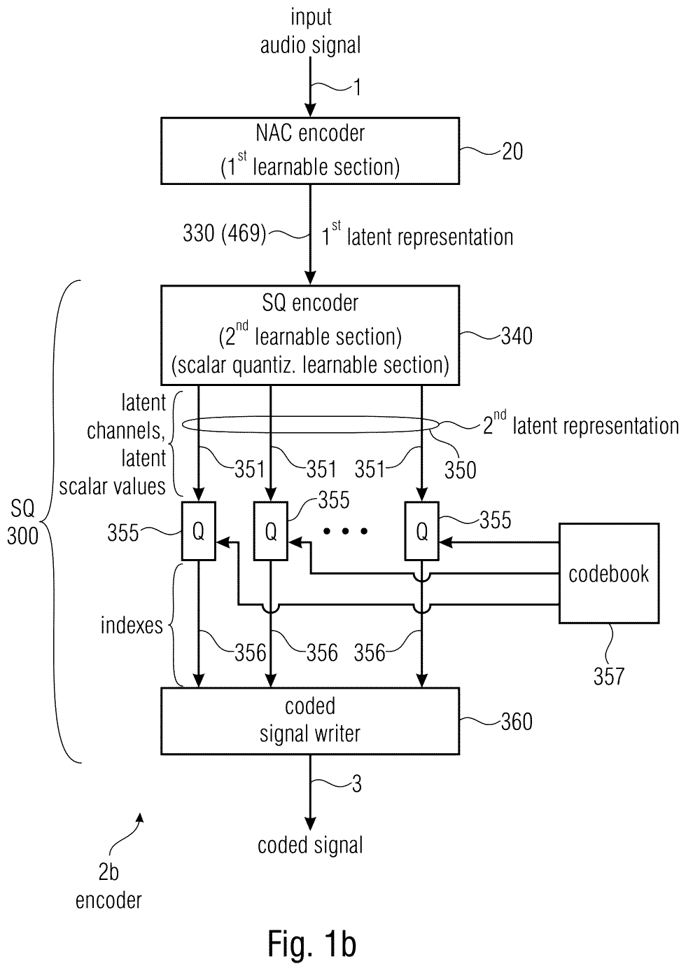

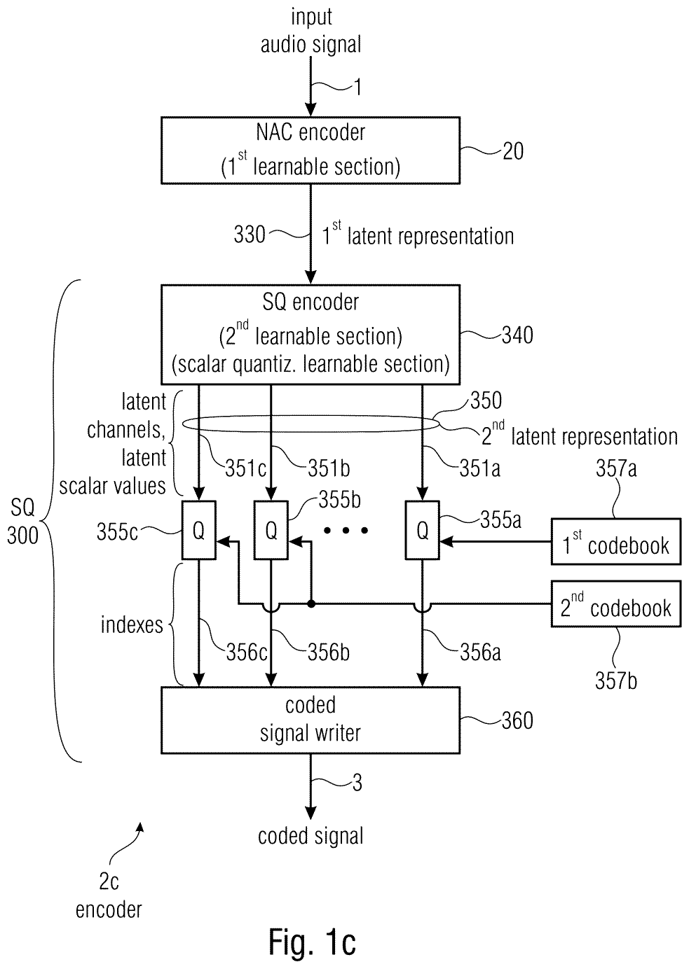

FIG. 1a shows an example of encoder 2 (some of its instantiations 2b, 2c are shown in FIGS. 1b, 1c). The encoder 2 (2b, 2c) may generate a coded signal 3 (e.g. bitstream, or part thereof), to encode an input audio signal 1 in the coded signal 3. The input audio signal 1 may be in frequency domain or in time domain (a time/frequency converter may be provided, either at the input of the encoder 2 or within the encoder 2). The input audio signal 1 may be, for example, subdivided into a succession of frames, e.g. either distinct from each other or overlapped. The coded signal 3 generated by the encoder 2 may be (or be part of) a bitstream. The input audio signal 1 may be a mono signal. In case of encoding a spatially multi-channel signal (e.g. stereo signal), it may be, in some examples, that multiple input audio signals 1 are encoded in parallel and independently using the processing here described thereby generating multiple coded signals 3, e.g. written in the same bitstream. Alternatively, the multiple spatial channels can be linearly combined, like Mid spatial channel and Side spatial channel in case of stereo, before being conveyed to multi-instances of the encoder 2. The coded signal 3 may be transmitted, e.g. through transmission equipment (e.g. in a communication network), such as wired or wireless communication equipment, to a decoder (e.g., through a client/server connection or a point-to-point connection) and/or stored in a storage unit, e.g. to be subsequently be read by a decoder (e.g. the decoder 10, see below).

The encoder 2 may include a first learnable section 20. The first learnable section 20 may include at least one learnable layer (e.g. neural network, with for example convolutional layer(s) and/or recurrent unit(s) and/or fully connected layer(s)) to provide a first latent representation 330 (also indicated as 469 in some examples) of the input audio signal 1. The first latent representation 330 (469) may be represented, in some examples, as a matrix (e.g. an M×N matrix) with M>1 and N≥1 (M may be understood as the number of latent channels in the case of a vector, i.e. M×1 matrix). The first latent representation 330 (469) may be represented, in some examples, as a vector (with M entries, each being a latent scalar value or latent channel, e.g. with M>1). It may be, however, that the number M of rows in the matrix is less than the original number of samples within each frame. However, the reduced number of rows with respect to the samples may be compensated by the number N of columns being greater than 1. It may be, for example, that M is the number of latent channels, and N the length of the frame. It is to be noted that each frame may be subdivided among a plurality of vectors and each vector into a plurality of latent channels (the latent channel dimension may correspond to the column dimension in some examples), each latent channel having one single latent scalar value to be encoded. In some examples, the first learnable section 20 may generate the first latent representation 330 independently from a bitrate (e.g. for any bitrate of the coded signal 3, the first latent representation may remaining the same, with the same resolution, and with the same M numbers of latent channels for each frame), and/or independently from the resolution to be given to the coded signal 3, and/or independently from others selections that may be performed, and/or independently from the input audio signal itself.

The encoder 2 may include a scalar quantization (SQ) module 300, receiving the first latent representation 330 (469). The scalar quantization module 300 may have the task of quantizing the first latent representation 330, e.g. latent-channel-by-latent-channel (latent-scalar-value-by-latent-scalar-value).

The scalar quantization module 300 may comprise a second learnable section 340. The second learnable section 340 may provide, from the first latent representation 330, a second latent representation 350. The second latent representation 350 may include a plurality of latent scalar values 351 (e.g. each scalar value for each latent channel, i.e. each scalar value of the latent representation 330). The second learnable section 340 may include at least one learnable layer. The output of the second learnable section 340 may be a plurality of latent scalar values 351. In some examples, the number of latent channels (latent scalar values) for each frame may be varied (e.g., reduced), or more in general varied (e.g. selectably reduced) e.g. under a selection exerted by a controller 358 (see below).

(It is to be noted that the first learnable section 20 may, in some examples, be set for all bitrates, while the second learnable section 340 may closely associated to a given set of scalar quantizers/codebook. In other words, the first latent representation 330 may be a generic representation of the input audio signal 1, while second latent representation 350 may be a specific latent representation for a given set of scalar quantizers 355, e.g. targetting a specific bit-rate.)

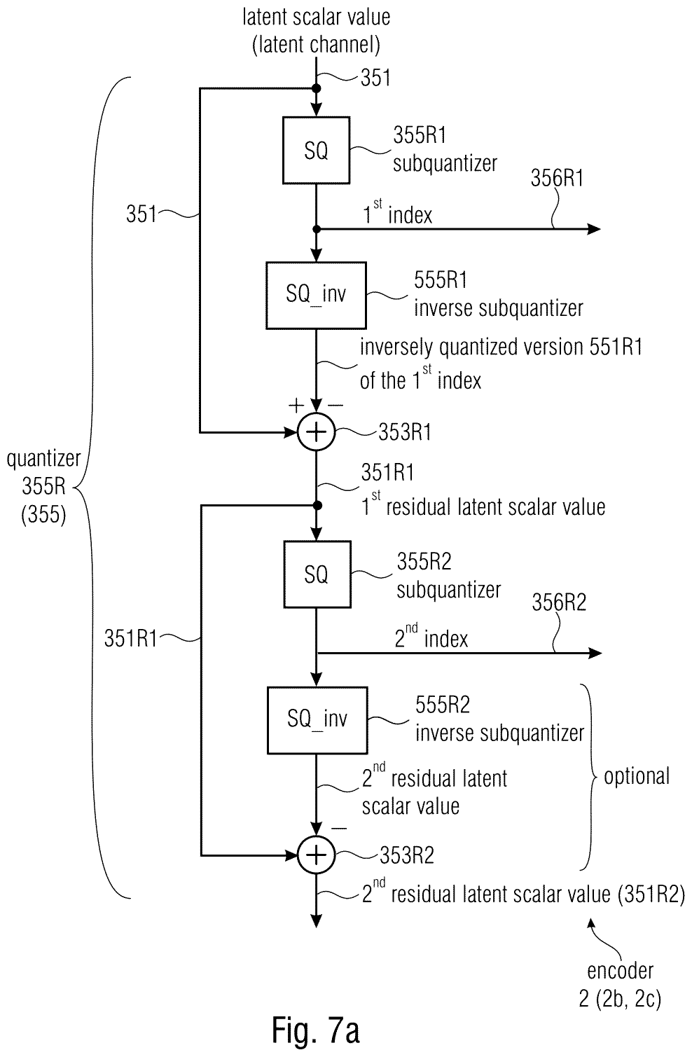

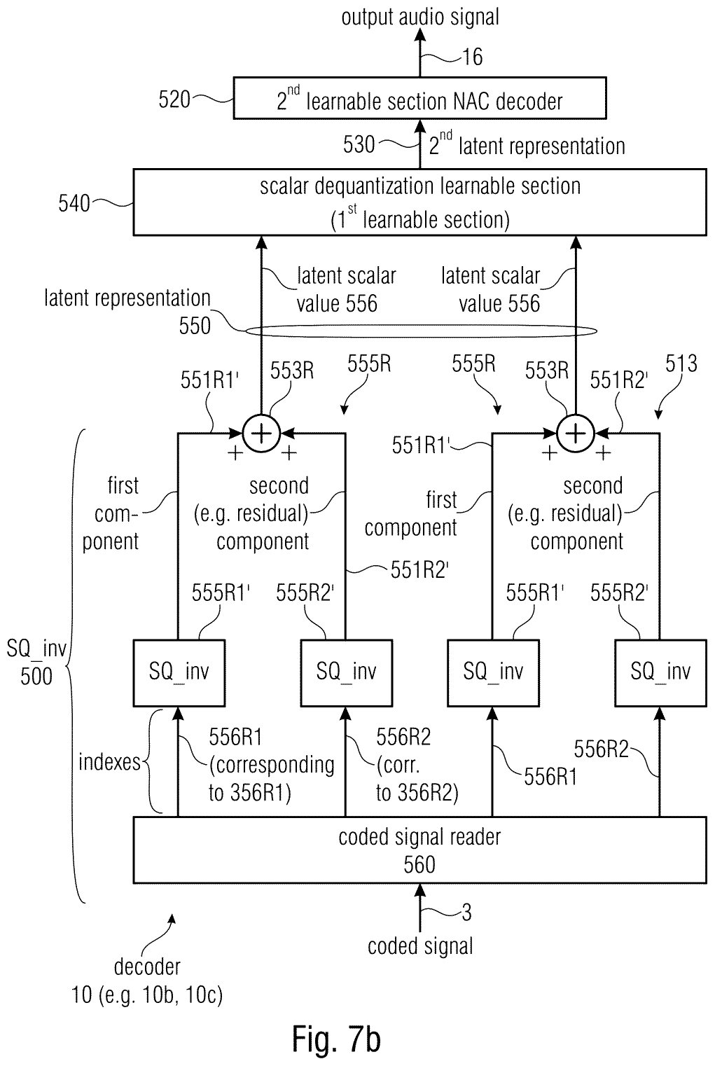

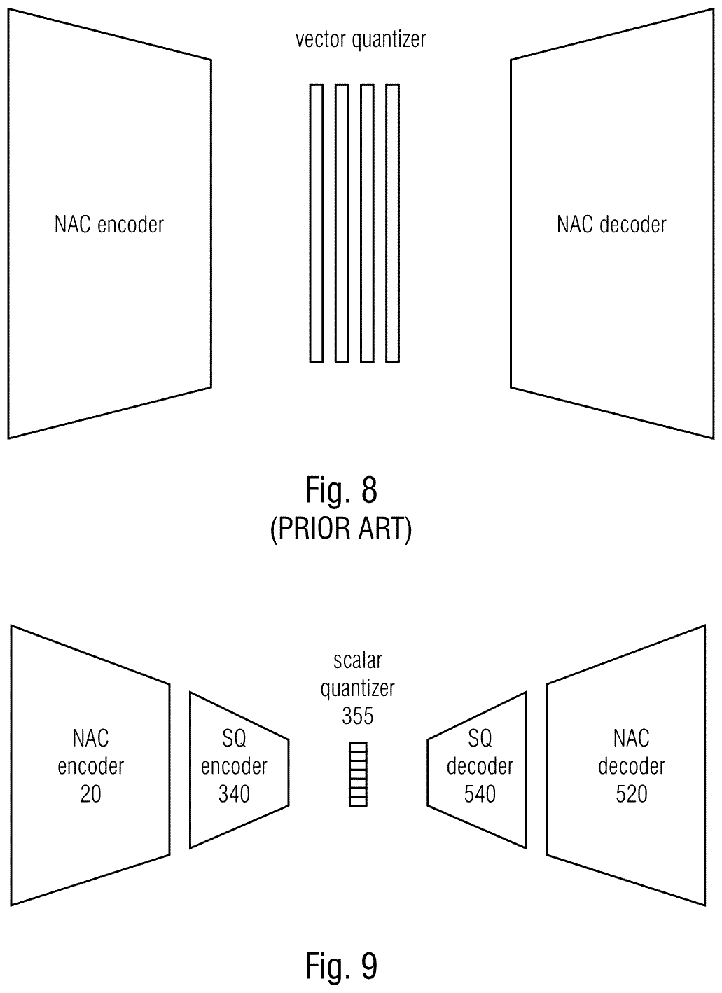

The scalar quantization module 300 includes a plurality of quantizers 355. Each quantizer 355 of the plurality of quantizers may provide one single index 356 for the respective latent scalar value 351 (e.g. for the respective channel) (it will be shown, in a multistage example, e.g. in FIG. 7a, that there may be more indexes 356R1 and 356R2 from one single scalar value 351). Therefore, the plurality of quantizers 355 may complexively provide a plurality of indexes for each frame (and for the latent representations 330 and 350) of the input audio signal 1. Each index 356 may have a length of a number of bits which may be, for example, between 3 and 8, or more in particular between 3 and 6, or even more in particular between 2 and 5.

(Each quantizer 355 may realize a mapping from an (e.g. approximately) real-valued representation 351 to a discrete-valued representation 356 taken from a set of plural finitely values. The mapping is applied latent-channel-wise and may differ per latent channel: e.g., a different number of codebook/quantization levels may be different for different quantizers 355. The number and position of the “quantization levels” are parameters of each scalar quantizers 355 and quantizer and quantization levels are different objects (the latter one is a building block of the first).)

The quantizers 355 are multiple because the latent channels (latent scalar values) 351 are multiple (e.g., for each frame there are multiple channels, i.e. multiple scalar values 351 for the representation 330 or 350), and each quantizer 355 converts one single particular scalar value (in a particular latent channel) onto one single particular index.

There may be a fixed relationship between the specific quantizer 355 that is to be used and the particular position in the vector of the latent representation of the audio signal 1. Hence, each specific quantizer 355 may be applied to a particular latent channel (latent scalar value) according to the particular position in the latent representation (330 or 350) which represents the audio signal 1.

Since the indexes 356 are obtained from the latent scalar values 351 of the second latent representation 350, the set of indexes formed from the latent scalar values 351 of each represent a quantized latent version of the audio signal 1 (e.g. for one frame).

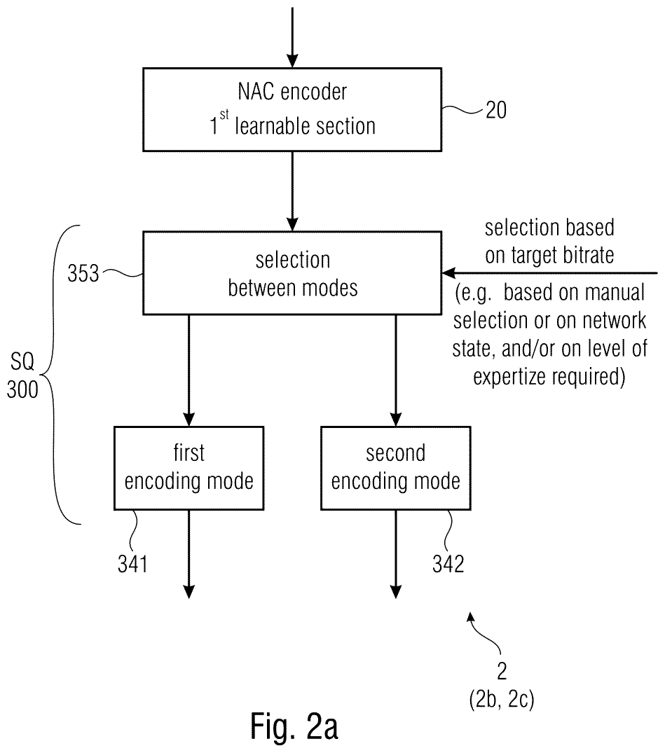

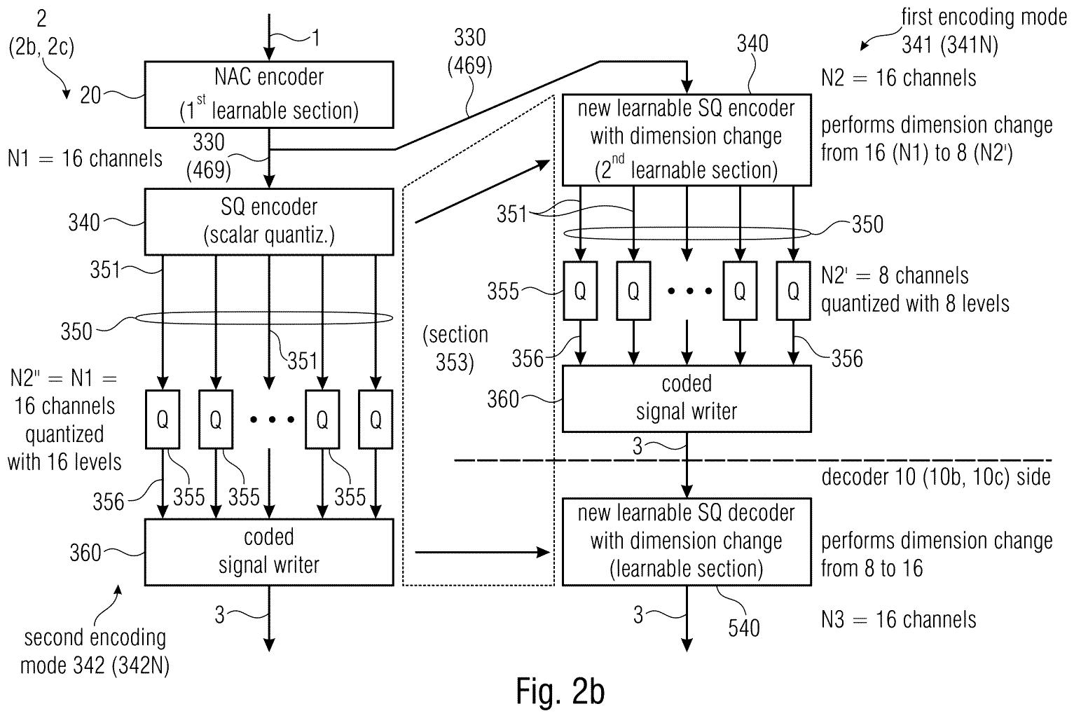

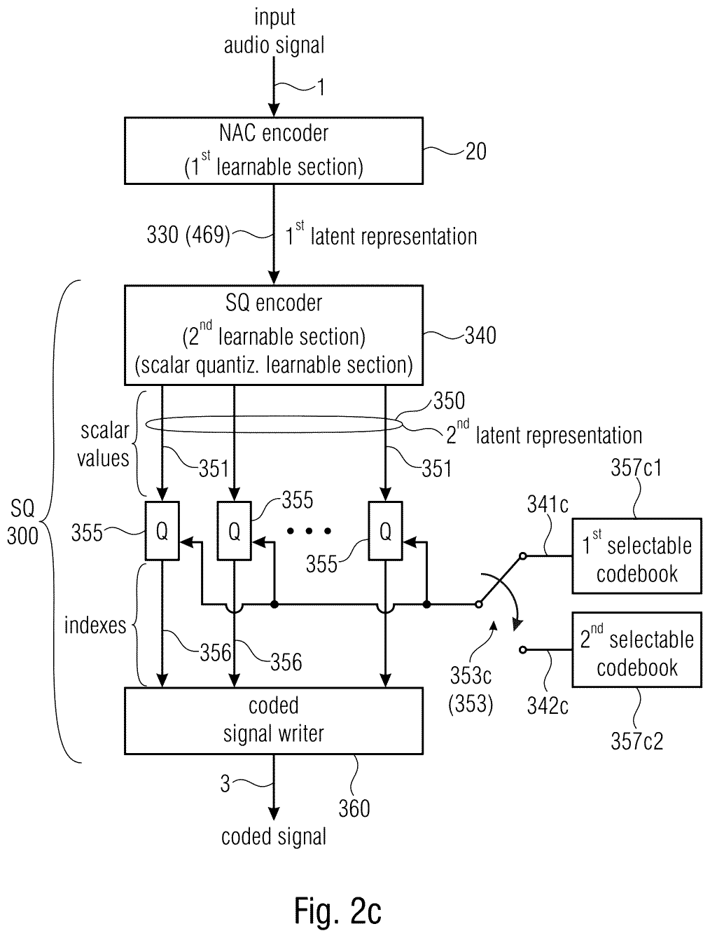

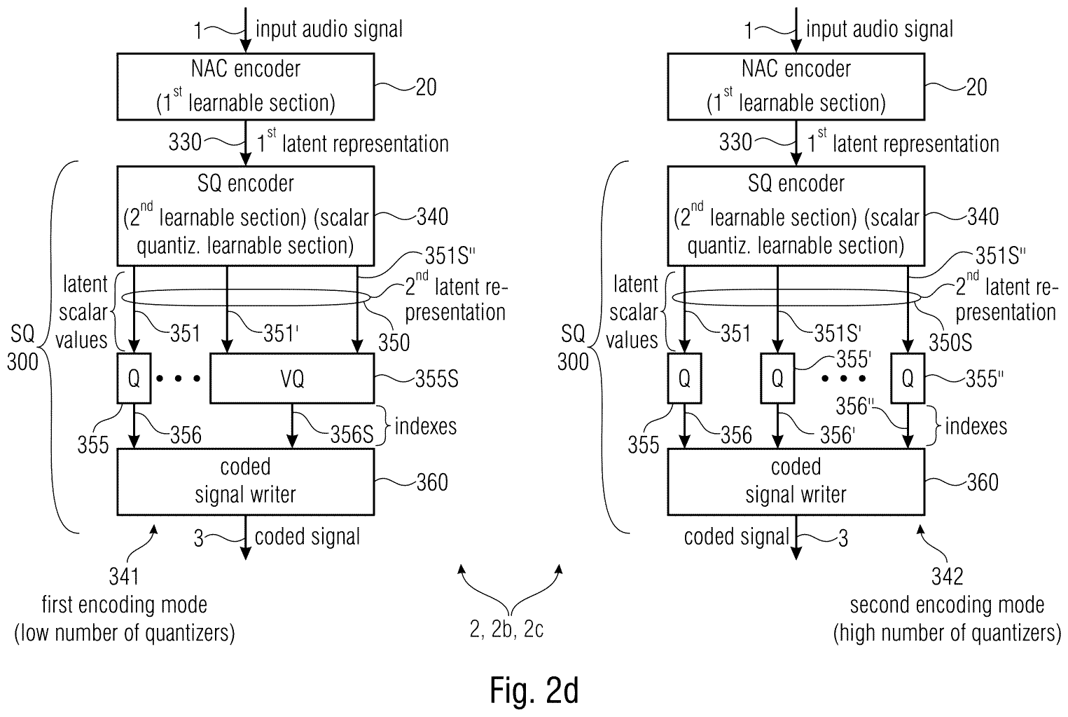

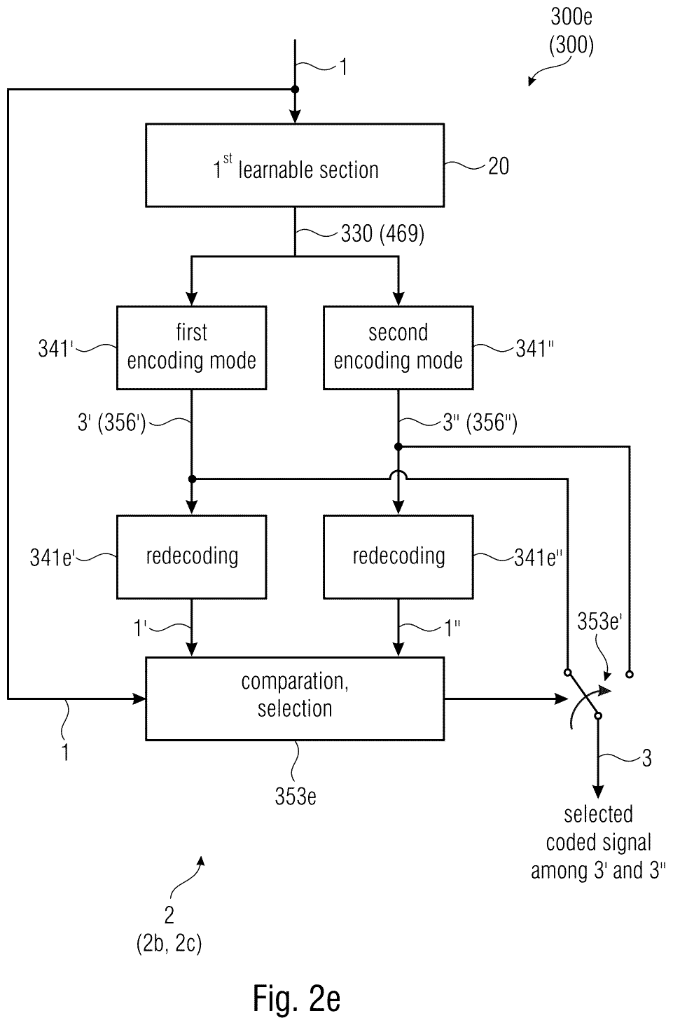

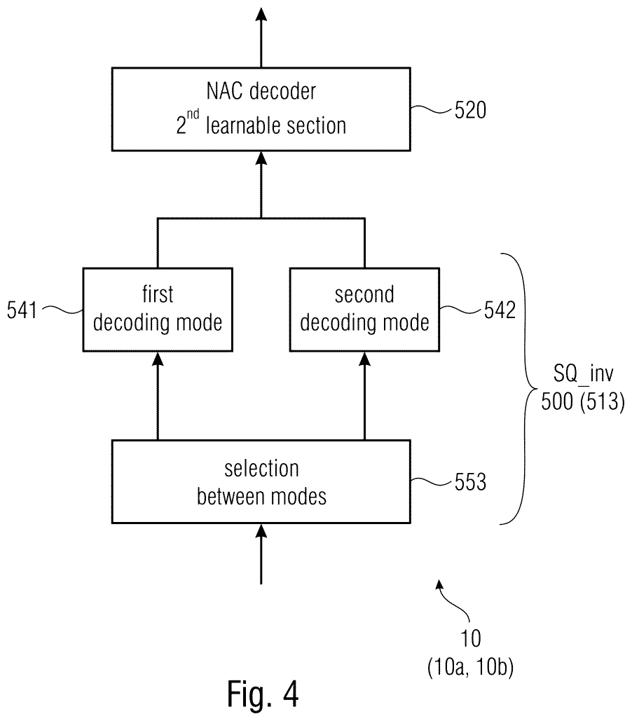

With reference to FIGS. 2a and 4, selections 353 and 553, respectively, may be performed at the encoder and the decoder, respectively, so as to select one encoding mode out of at least one first encoding mode 341 and one second encoding mode 342 and to select one decoding mode out of at least one first decoding mode 541 and one second decoding mode 542, respectively.

In some examples, the second learnable section 340 may vary the number of latent channels (latent scalar values) between its input 330 and its output 350: the second learnable section 340 may change (e.g. decrease) the number of latent channels (latent scalar values) for each frame, so that the second latent representation 350 may have a different number of latent channels (latent scalar values) with respect to the number of latent channels (latent scalar values) the first latent representation 330. By virtue of the change in the number of channels (latent scalar values) in the latent representation (from 330 to 350), also the quantizers 355 change in number and also the number of indexes 356 changes accordingly. In some examples, this may be a selection of modes (see also below). In general terms, the second learnable section 340 may convert a first number N1 of latent channels (latent scalar values) of the first latent representation 330 (469) onto a second number N2 (with normally N2<N1) of latent channels (latent scalar values) 351 of the second latent representation 330 (e.g. for each frame). An example can be that N1=16 and N2=8 (or N1=64 and N2=16 or N2=32; other values are possible).

In some examples, the number of latent channels (latent scalar values) for each frame may vary (e.g. selectably), e.g. based on a selection (e.g., a user's selection, or a selection controlled by an automatic means), e.g. adaptively (e.g. in such a way to be adapted to the particular audio signal 1, in particular to a particular frame, or sequence of frames, of the audio signal 1).

The encoder 2 may include a coded signal writer 360, which writes (e.g. by encapsulating) the plurality of indexes 356 into the coded signal 3. Even if in the figures the coded signal writer 360 is represented as being part of the scalar quantization module 300, the coded signal writer 360 may be external to the scalar quantization module 300. However, for simplicity, the coded signal writer 360 is represented in the figures as internal to the scalar quantization module 300, despite it may be external in any of the examples below.

The coded signal writer 360 may also include additional coding tools, like an entropy coder, aiming to compress, losslessly further the quantization indexes, by using variable length codes, depending on estimated and/or pre-computed probabilities of the occurrences of the different quantization indexes. For example the entropy coding can use at least one among Huffman codes, arithmetic coding range coding, and Golomb-rice code.

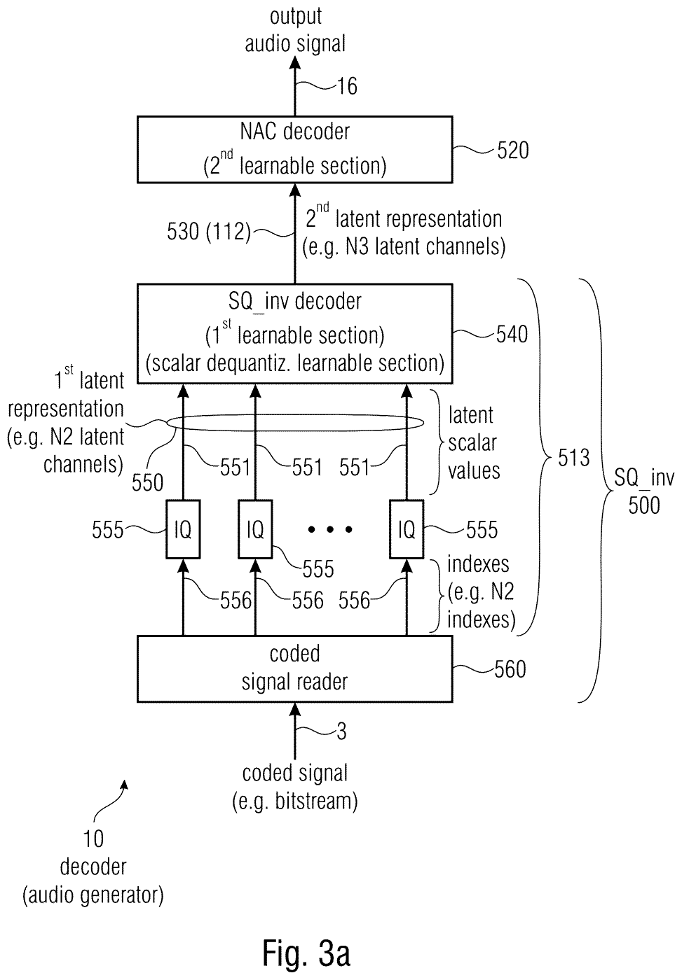

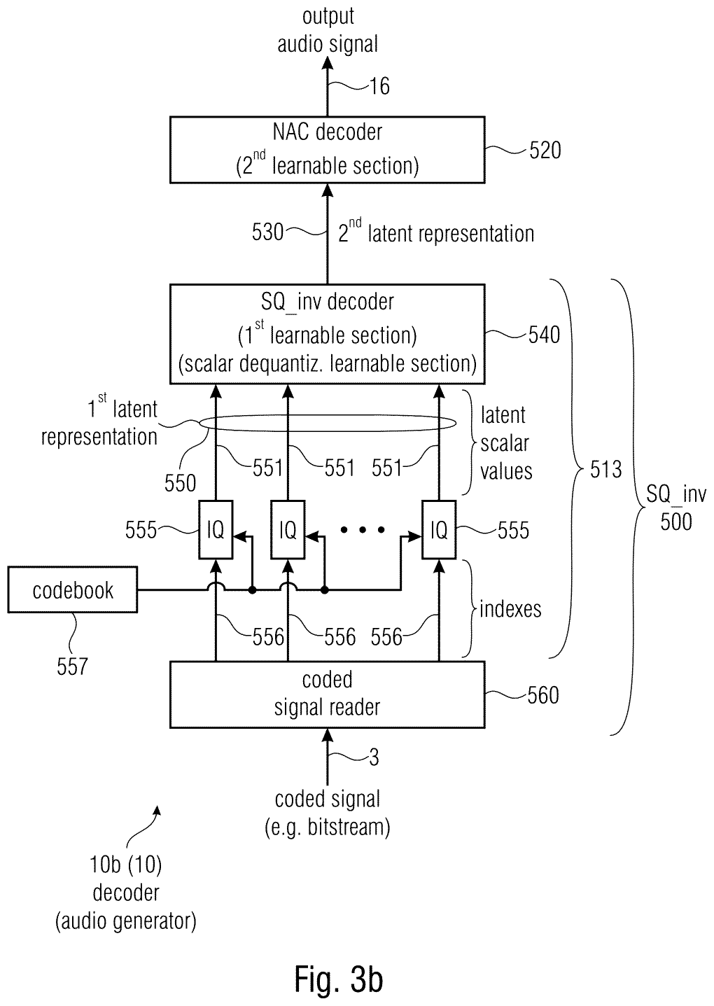

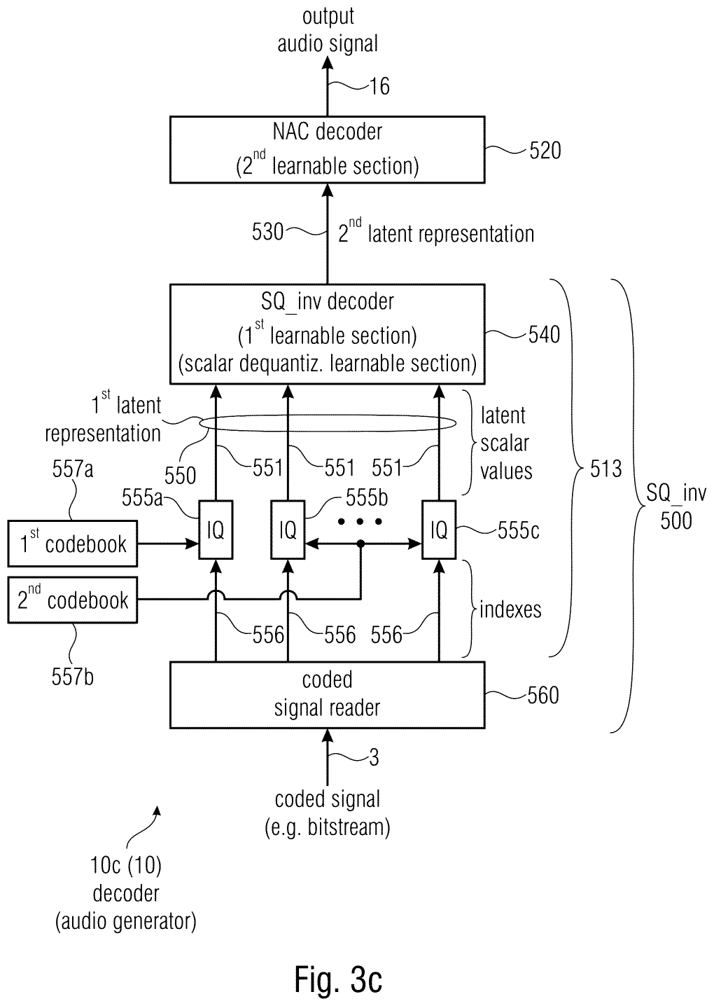

With reference to FIG. 3a, a decoder (audio generator) 10 (e.g. capable of decoding the coded signal 3 generated by the encoder 2, e.g. 2b, 2c) is here presented. The decoder 10 (which may be instantiated, for example, by decoder 10b of FIG. 3b or decoder 10c of FIG. 3c) may generate an output audio signal 16, which is intended to be a copy, possibly trustful, or a high-fidelity approximation of the input audio signal 1. The output audio signal 16 may e.g. be for example, rendered e.g. through loudspeakers downstream to or included in the decoder 10. In addition or alternative, the decoder 10 (e.g. 10b, 10c) may encode the generated audio signal 16 onto another encoded signal representation, and may therefore operate as a transcoder.

The decoder 10 (e.g. 10b, 10c) may include a coded signal reader 560, which may read the coded signal 3. The coded signal reader 560 may output a plurality of indexes 556, which may the same of the indexes 356 outputted by the quantizers 355 of the encoder 2.

The coded signal reader 560 may also include additional inverse coding tools, like an entropy decoder, aiming to decode entropy coded quantization indexes. For example the entropy decoding can support at least one of Huffman codes, arithmetic coding range coding, and/or Golomb-rice code, etc.

The decoder 10 (e.g. 10b, 10c) may include a scalar dequantization module 500, which may provide a second latent representation 530 (also referred to with codes 112) of the audio signal 16 to be generated. Even if in the figures the coded signal reader 560 is represented as being part of the scalar dequantization module 500, the coded signal reader 560 may be external to the scalar dequantization module 500. Here, reference 513 is provided for indicating the scalar dequantization module 500 without the coded signal reader 560.

The dequantization module 500 (513) may include a plurality of quantization index converters (inverse quantizers) 555, each of them being configured to convert one single index 556 (or more than one index 556R1, 556R2 in the residual technique, e.g. in FIG. 7b) onto one single latent scalar value 551. Therefore, it may be that, in some examples, each frame of the input audio signal 1 (and of the output audio signal 16 to be generated) may be mapped by a plurality of latent scalar values 551. The latent scalar values 551 may form a first latent representation 550 of the audio signal 16 to be generated. The latent scalar values 551 may be seen as corresponding to the latent scalar values 351 at the encoder 2, and the first latent representation 550 of the audio signal 16 to be generated may be seen as corresponding to the second latent representation 350 of the input audio signal 1 at the encoder 2. In some examples, the number and/or the configuration of the quantization index converters (inverse quantizers, inverse dequantization levels) 555 is due to the number N2 of indexes 356 written by the encoder 2 (e.g. 2b, 2c): for example, if the encoder has encoded a frame with 16 indexes (using therefore 16 quantizers 355), the decoder 10 (e.g. 10b, 10c) will consequently use 16 quantization index converters 555, while if the encoder has encoded a frame with 8 indexes (using therefore 8 quantizers 355), the decoder 10 (e.g. 10b, 10c) will consequently use 8 quantization index converters 555, and so on. Therefore, in some examples, the number of quantizers 555 used for each frame may change, e.g. in accordance to the number of indexes 556 written in the coded signal 3 for each frame (e.g. selectably, e.g. through a selection, and in particular adaptively, e.g. based on the particular audio signal encoded in the coded signal 3, e.g. according to a signalization written in the coded signal 3 as side information).

The quantization index converters 555 are multiple because the latent scalar values 551 to be generated are multiple (e.g., for each frame there are multiple scalar values 551), and each quantization index converter 555 converts each index 556 onto one particular scalar value of the matrix (e.g. vector). More in general, there may be a fixed relationship between the specific quantization index converter 555 that is to be used and the particular position in the vector of the latent representation of the audio signal 16 to be generated (and of the input audio signal 1, as well). Information on the relationship may be signalled in the coded signal 3, or may be other ways be obtained from the coded signal 3 (e.g., it can be assumed from the particular position of the index in the coded signal 3).

The dequantization module 500 (513) may include a first learnable section (scalar dequantization learnable section) 540, which may receive the latent scalar values 551 of the first latent representation 550 and generate a second latent representation 530 (e.g. in form of codes 112, e.g. in two dimensions). The first learnable section (scalar dequantization learnable section) 540 may be seen as corresponding to the second learnable section 340 of the encoder 2, and the second latent representation 530 may be seen as corresponding to the first latent representation 330 (469) at the encoder 2. It is to be noted, however, that, even in the cases in which the encoder-side second learnable section 340 has (e.g. selectably, e.g. adaptively) changed (e.g. reduced) the number of scalar values from the first number N1 of latent channels (latent scalar values) in the encoder-side first latent representation 330 to a second number N2 of latent channels (latent scalar values) 351 in the decoder-side second latent representation 350, the number of latent channels 551 in the decoder-side first latent representation 550 can remain N2, but the number N3 of latent channels in the decoder-side second latent representation 530 can be in general independent of N1 (it could be indifferently N3>N1, N3<N1, or N3=N1) (It may be advantageous that N3>N2, to have the output audio signal 16 with a good resolution, while the coded signal 3 has advantageously a small number of indexes). Therefore, the decoder-side second latent representation 530 may convert the number of latent channel (latent scalar values) from the number N2 of indexes 556 obtained from the coded signal 3 to the number N3 which is required by the second learnable section 520 and which is in general independent from the coded signal 3 and/or from the bitrate, and/or from other selections. Therefore, the second learnable section 340 may convert the number of latent channel (latent scalar values) from the number N1 of the first latent representation 330 (which is application-side, and can be in general independent on the bitrate and/or on selections) to the number N2 (which may be in general N2≤N1) and which may be adapted to conditions such as target bitrate, selections, etc.

The decoder 10 (e.g. 10b, 10c) may include a second learnable section (e.g. neural audio coding, NAC, decoder) 520. The second learnable section 520 may output the audio signal 16. The second learnable section 520 may be seen as corresponding to the first learnable section 20 of the encoder 2. It is to be noted, however, that it is not necessary that the decoder-side second learnable section 520 is specular to the encoder-side first learnable section 20. Basically, it is for the decoder not strictly required to mirror the operations of the encoder.

In general terms, the operations of the second learnable section 520 of the decoder 10 (e.g. 10a, 10b) may be seen as being independent from the bitrate of the coded signal 3 and/or independent from at least one of the features of the signal coded 3 and/or on selections.

Both the quantizers 355 of the encoder 2 and the quantization index converters (inverse quantizers) 555 of the decoder 10 may make use of at least one codebook, which is not shown in FIGS. 1a and 3a. The at least one codebook may be either learnable or deterministic, at the encoder 2 and/or the decoder 10. Some examples are here described.

At least one (or each) codebook may perform an association between scalar values and indexes, e.g. by mapping, at the encoder, each one scalar value 351 onto a particular index 356, and, vice versa, by mapping, at the decoder, an index 556 onto one particular scalar value 551. In some cases at least one codebook may have a fixed length (i.e. the codebook has a variable-length bitstream representation), in the sense that all the indexes 356, 556 have the same length (e.g. all indexes having 4 bits). In other cases, the codebook may have a variable bitlength (i.e. the codebook has a fixed-length bitstream representation), so that different indexes 356, 556 may have different lengths (e.g., more frequent scalar values may be mapped onto indexes which are more compact, e.g. which have less elongated length, while less frequent indexes or scalar values may be mapped onto indexes which are less compact, e.g. which have more elongated length; this may be valid, for example for at least two indexes, or for a plurality of the indexes, or for the majority of the indexes, or for the all indexes). At least one (or each) codebook may have a variable precision, in the sense that some indexes approximate scalar values better (e.g. with less uncertainty) than some other indexes: for example, ranges with more frequent scalar values may be mapped onto a number of indexes which is greater than the number of indexes onto which ranges with less frequent scalar values are mapped, e.g. in respect to the elongation of the ranges: therefore, the approximation uncertainty is reduced for the scalar values in the highly frequent ranges, thereby increasing precision, while the low-frequent ranges of scalar values there are fewer indexes, each having more uncertainty. Summarizing, the codebook or quantization may be non-uniform, where the value range to quantize is divided into unequal intervals, in such a way that more frequent intervals are smaller than less frequent intervals. This subdivision may different between different codebooks, and may be defined during training.

The at least one codebook may permit, at the quantizers 355 of the encoder 2, to convert one single latent scalar value 351 onto one single index 356. At each of the quantization index converters 555 of the decoder 10, the at least one codebook may permit to convert one single index 556 onto one single latent scalar value 551.

In some cases, at least one quantizer 355 (e.g. all the quantizers) or at least one quantization index converter 555 (e.g. all the quantization index converters) may have a plurality of levels, as shown in FIGS. 7a and 7b. Each level may be associated to a particular codebook, or all levels may share the same codebook, in some examples.

FIG. 1b shows an example of an encoder 2b (which may be an instantiation of the encoder 2) in which one single codebook 357 shared by the plurality of quantizers 355 in the encoder 2b. Therefore, in the example of FIG. 2b equal latent scalar values 351, quantized by different quantizers 355, will be mapped by the same index 356, by virtue of the different quantizers using the same codebook 357. As shown in the decoder 10b (which may be an instantiation of the decoder 10) of FIG. 3b, dually, one single codebook 557 may be shared by the plurality of quantization index converters 555: equal indexes 556, once converted by different quantization index converters 555, will be mapped by the same latent scalar values 551. The use of one single codebook (e.g. 357, 557) for all the quantizers 355 (respectively quantization-index-converters 555) may have some advantages, in that less storage space is required for storing the single codebook, and less computational effort is necessary during training.

FIG. 1c shows an example of an encoder 2c (which may be an instantiation of the encoder 2) in which at least one quantizer 355a (e.g. all the quantizers) uses one quantizer-specific codebook 357a. Even though FIG. 1c also shows that one shared codebook 357b which is shared by a multiplicity (e.g., by a proper subset of the plurality) of the quantizers 355 (in the example of the figure instantiated by quantizers 355b and 355c) in the encoder 2c, this is not necessary: it may be that each of the quantizers have a quantizer-specific codebook. Since each latent scalar value (quantized by a respective quantizer to provide a respective index) may have a specific relationship with the particular position in the latent representation (e.g. a matrix, such as a vector), also each quantizer-specific codebook may have a specific relationship with a particular position of the latent representation. For example, there may be different codebooks for different positions. FIG. 3c shows an example of a decoder 10c (which may be an instantiation of the decoder 10), which dually may apply at least one quantizer-specific codebook: at least one quantization-index-converter 555a (e.g. all the quantization-index-converters) may use one quantization-index-converter-specific codebook 557a, while the remaining quantization-index-converters 555b, 555c may use at least one shared codebook 557b. Since each latent scalar value (to be generated by a respective quantization-index-converter from a respective index) may have a specific relationship with the particular position in the latent representation (e.g. a matrix, such as a vector), also each quantization-index-converter-specific codebook may have a specific relationship with a particular position of the latent representation. For example, there may be different codebooks for different positions. The use of multiple, quantizer-specific codebooks (e.g. 357a) (respectively multiple quantization-index-converter-specific codebooks) may have some advantages, in that an increased precision may be reached: probabilistically, some intervals of scalar values may be more frequent in first positions of the latent representation, while other intervals of scalar values may be more frequent in second positions of the latent representation. For this reason, each quantizer-specific codebook (respectively each quantization-index-converter-specific codebook) may define a different association to different positions in the latent representation. For example in each position of the latent representation, a first interval of highly frequent scalar values will be mapped by a first, great number of indexes (thereby with low approximation error), while, in the same first position, a second intervals of non-frequent scalar values will be mapped by a lower number of indexes (thereby with high approximation error). Therefore, during training, each position of the latent representation is awarded with a distribution of indexes representative of the probability of each interval of scalar values. Said in another way, each index approximates a little segment of scalar values in the highly-frequent intervals, and a long segment of scalar values in the low-frequent intervals. In general terms, the global value range to quantize may be divided into non equal intervals.

As shown in FIGS. 2a and 4, encoder 2 (2b, 2c) and/or the decoder 10 (10b, 10c) may operate according to different, but at least with two modes:
a first mode (first encoding mode 341 at the encoder; first decoding mode 541 at the decoder); and
a second mode (second encoding mode 342 at the encoder; second decoding mode 542 at the decoder);
optionally further modes (e.g. at least one further encoding mode and/or at least one further decoding mode) may be defined.

Often, the different modes can provide different qualities. For example, the first mode 341, 541 may provide a reduced quality (e.g. reduced resolution) with respect to the second mode 342, 542, but may also imply a reduced bitrate and/or require a reduced computational power than the than the second mode 342, 352. A selection (353 at the encoder; 553 at the decoder) may be performed to choose between the modes.

However, in some examples, different modes may simply behave differently. For example, different modes may be used for different situations, e.g. for different classification results of the audio signal 1, and are therefore called classification modes. For example, where a frame is classified as voiced frame, then a voiced-oriented classification mode may be selected, while in case of a frame classified as unvoiced frame, then an unvoiced-oriented classification mode may be selected.

In some examples, the modes are uniquely internal to the quantization module 300 (for the encoder) and the dequantization module 500 (513) for the decoder, and are completely ignored by the first learnable section 20 of the encoder and/or by the second learnable section 520 of the decoder.

Different modes may be obtained using different training sessions (which may be independent, for example, from the training sessions for the first learnable section 20 and the second learnable section 520). Different modes can imply different instantiations of the quantization module 300 or dequantization module 500 (513).

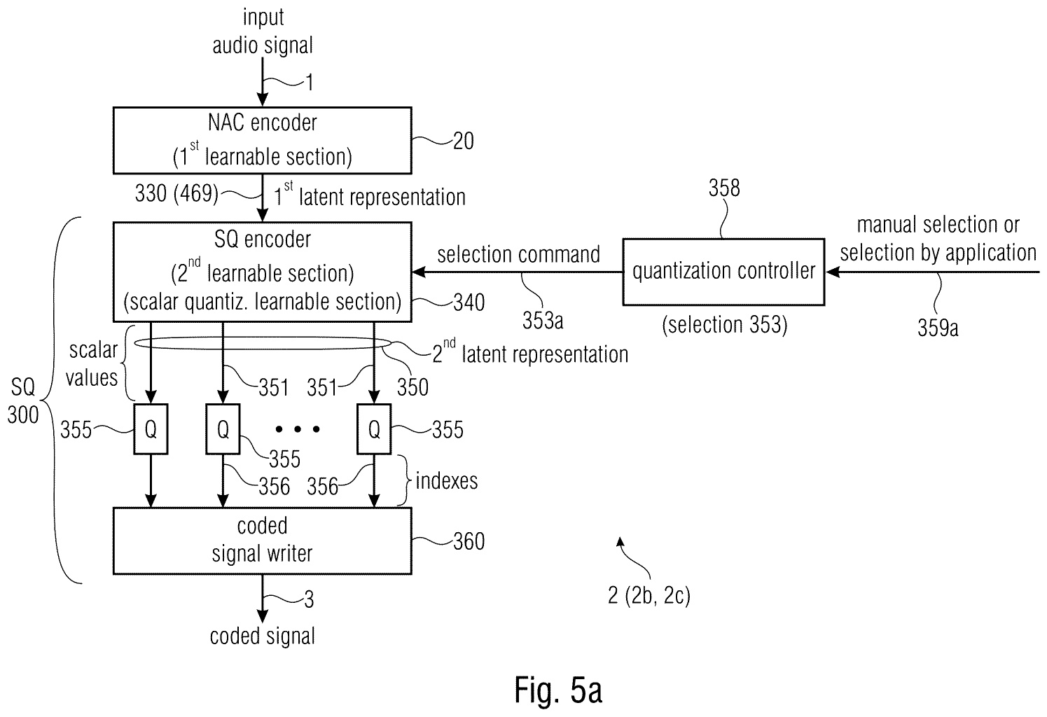

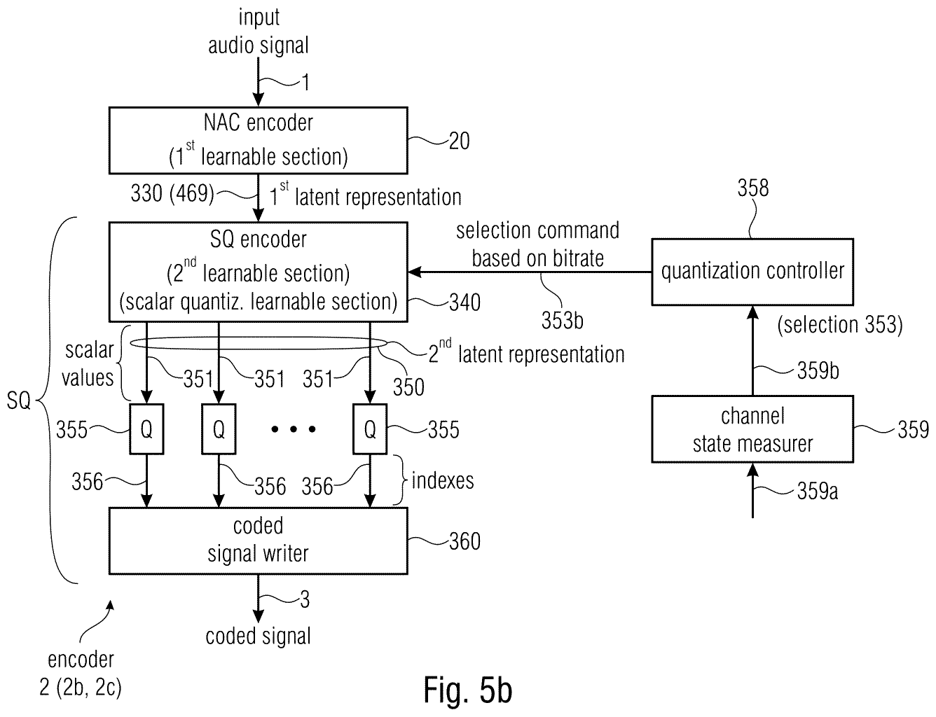

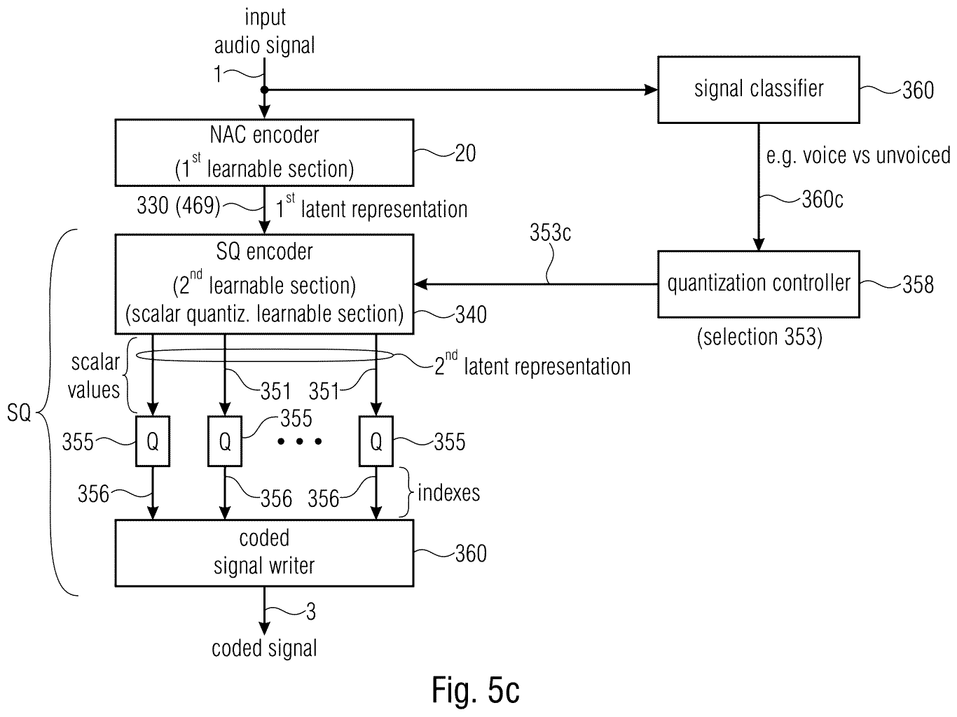

Examples of selections between the first encoding mode 341 and the second mode 342 are provided by FIGS. 5a-5c:
as shown in FIG. 5a, the selection 553 (e.g. through a selection command 353a, e.g. from a quantization controller 358) may be at least partially based on a signal 359a indicating a manual selection or a selection by application;
as shown in FIG. 5b, the selection 353 (e.g. notified through a selection command 353b, e.g. from the quantization controller 358) may be at least partially based on a signal 359b indicative of a state 359a of the communication link (e.g. the communication network), e.g. as measured by a channels state measurer 359, so as to be adapted to the status of the communication link; and
as shown in FIG. 5c, the selection 353 (e.g. notified through a selection command 353c, e.g. from the quantization controller 358) may be at least partially based on a classification result 360c indicative of a classification (e.g. performed by a signal classifier 360) performed on the input audio signal 1 (e.g. to the particular frame), so as to be adapted to the particular input audio signal 1 (the classification result 360c may discriminate, for example, between a voiced frame and an unvoiced frame).

Notably, the examples of FIGS. 5a-5c may be combined with each other: the selection 535 may be based on any of (or any combination among) the classification result 360c, state 359a, and selection 359a, according to a particular criterion.

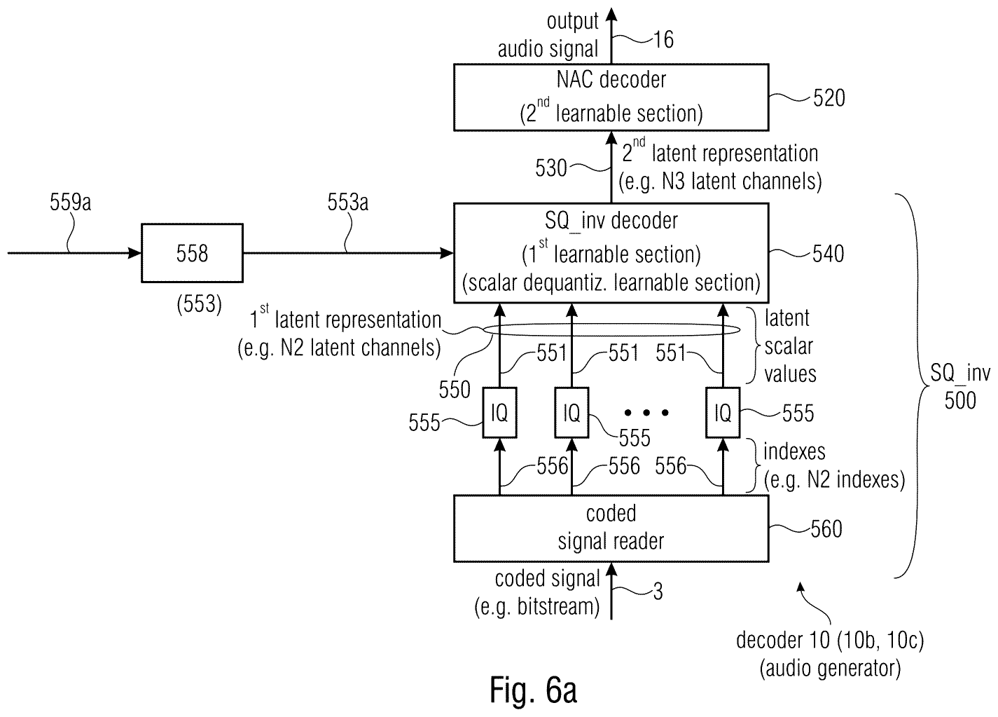

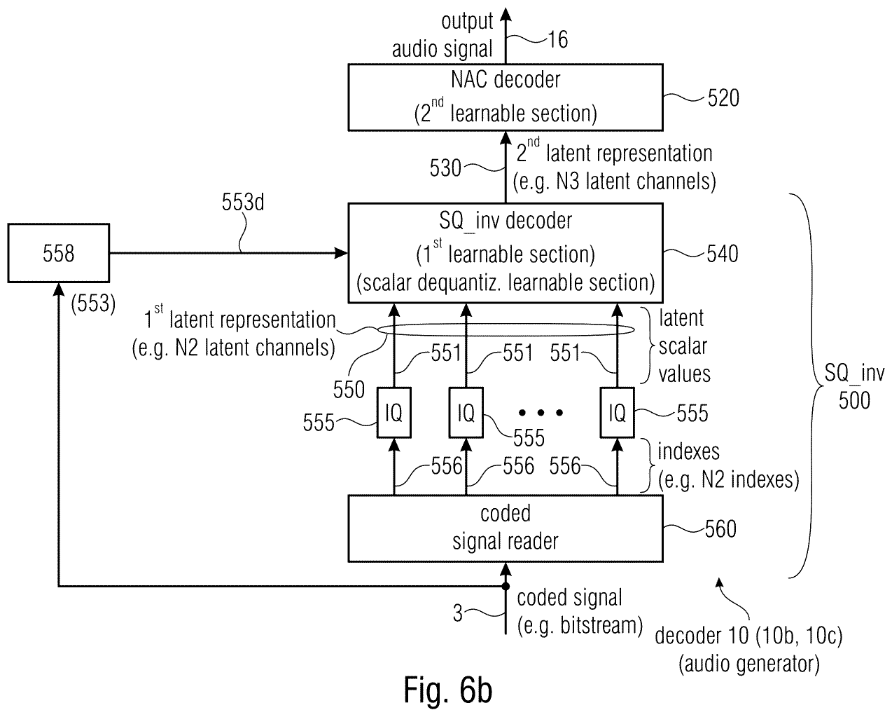

FIGS. 6a-6b show examples at the decoder 10, (10b, 10c). In general terms, the selection 553 may be performed (e.g., by a dequantization controller 558) as above in at least some examples. FIG. 6a (dual to FIG. 5a) shows the example in which the selection 553 is based on a user's selection 559a and/or a application selection 559a. Examples dual to those of FIGS. 5b and 5c are not shown, but implementable. FIG. 6b shows an example in which the selection 553 (e.g. notified through command signal 553d) is performed from side information in the coded signal 3 (e.g. following the selection 353 carried out by the encoder, and signalized as side information in the coded signal 3).

FIG. 2b shows an example of selection as a quantizers-number-oriented selection 353. The selection 353 is here between a first encoding mode 341 (here indicated with 341N) and a second encoding mode 342 (here indicated with 342N). Here, the selection 353 may be between at least:
a first, low-quantizers-number, encoding mode 341 in which the number N2′ (e.g. N2′=8) of the latent channels (latent scalar values) 351 of the first latent representation 350 is low (and the number of quantizers 355 is also low); and
a second, high-quantizers-number, encoding mode 342 in which the number N2″ (e.g. N2″=16) of the latent channels (latent scalar values) 351 of the first latent representation 350 (and also the number of quantizers 355) is higher than the number N2′ in the first encoding mode.

Analogously, even if not explicitly shown, at the decoder there may be a selection 553 (e.g. required by the side information of the coded signal 3, as for FIG. 6b) between a first decoding mode 541 and a second decoding mode 542 Here, the selection 553 may be between at least:
a first, low-quantization-index-converter number, decoding mode 541 in which the number N2′ (e.g. N2′=8) of the indexes 556 and of the latent channels (latent scalar values) 551 of the first latent representation 550 is low (and the number N2′ of quantizers 555 is also low); and
a second, high-quantization-index-converter number, decoding mode 542 in which the number N2″ (e.g. N2″=16) of the indexes 556 and of the latent channels (latent scalar values) 556 of the first latent representation 350 (and also the number of quantizers 355) is higher than the number N2′ in the first encoding mode.

Notably, in this case the selections between the first mode and the second mode (at the encoder and/or at the decoder) may be performed independently of the encoder-side first learnable section 20 and/or of the decoder-side second learnable section 520. In general terms, the first, low-quantizers-number, encoding mode 341 and the first, low-quantization-index-converter-number, decoding mode 541 offer less quality (e.g. more poor resolution) than the second, high-quantizers-number, encoding mode 342 and the second, low-quantization-index-converter-number, decoding mode 542. However, the first, low-quantizers-number, encoding mode 341 and the first, low-quantization-index-converter-number, decoding mode 541 in general require a reduced bitrate than the second, high-quantizers-number, encoding mode 342 and the second, low-quantization-index-converter-number, decoding mode 542, and are therefore more appropriated e.g. in the case of the busy communication link. Advantageously, the selection 353 at the encoder may be based, for example, on a measurement 359b of the status 359a of the communication link (e.g. communication network), as in FIG. 5b. For example, in case of network having a low performance (e.g., high busy state and/or high error rate), the first mode (at both the encoder and decoder) may be selected thereby providing a low-bitrate version of the coded signal 3, while in case of good network's good performance (e.g., low busy state and/or low error rate), the second mode (at both the encoder and decoder) may be selected thereby providing a satisfactory audio quality.

It is also possible to have a number of modes which is more than two, each mode being associated, for example, to a respective bitrate and/or a respective resolution, so as the quantizer-oriented selection is performed to provide a good trade-off between the requested quality and the bitrate at disposal.

In some examples therefore, in the quantizer-oriented selection it may be summarized that, the higher the bitrate at disposal of the transmission of the coded signal 3, the higher the number of quantizers may be chosen (and, coherently, also the dimension of the encoder-side second latent representation 350 and the dimension of the decoder-side first latent representation 550).

It is to be noted that, in the case of the quantizer-oriented selection of FIG. 2b, the first, low-quantizer number, mode 341 and the first, low-quantization-index-converter number, mode 541 may also be considered as examples of a first, low-index number, mode, because the low number of indexes N2′ follows the low number of quantizers 355 and 555. Analogously, the second, high-quantizer number, mode 341 and the second, high-quantization-index-converter number, mode 541 may also be considered as examples of second, low-index number, modes, because the higher number of indexes N2″ follows the higher number N2″ of quantizers 355 and 555.

FIG. 2c shows an example of selection 353 as a codebook selection 353C. The selection 353C is here between a first encoding mode 341 (here indicated with 341C) and a second encoding mode 342 (here indicated with 342C). Here, the selection 353 may be between at least:
a first encoding mode 341 (341C) in which a first codebook 357C1 is used; and
a second encoding mode 342 (342C) in which a second codebook 357C2 is used.

Analogously, at the decoder a codebook the selection 553 may be performed between a first decoding mode 341 and a second decoding mode 342. Here, the selection 553 may be between at least:
a first decoding mode in which a first codebook is used; and
a second decoding mode in which a second codebook is used.

It may be, for example, that the second codebook for the second encoding/decoding mode has more indexes (or at least the majority thereof) and/or indexes with higher bitlength than the first codebook used for the first encoding/decoding mode. Therefore, a better resolution (but also a higher bitlength) can be in principle reached by the second encoding/decoding mode. In examples, the higher the bitrate, the higher the resolution, and the first mode is preferably selected.

Even FIG. 2c shows that the selectable codebooks are shared codebook, it may be (like in FIG. 1c) that quantizer-specific codebooks are selectable (i.e. the selection is between a first set of quantizer-specific codebooks and quantization-index-converter-specific codebooks and a second set of quantizer-specific codebooks and quantization-index-converter-specific codebooks).

It is also noted that in some examples a first mode may be both imply a quantizers-number-oriented selection and a codebook selection. For example:
a first, low resolution encoding/decoding mode may use a first, low bitlength, codebook (or a set of first, low bitlength codebooks) and a low number of quantizers (respectively quantization index converters), e.g. for reaching low resolution and high bitrate (e.g. in case of poor status of the communication link), by keeping the bitlength low; and
a second, high resolution encoding/decoding mode may use a second, high bitlength, codebook (or a set of second, high bitlength codebooks) and a high number of quantizers (respectively quantization index converters), e.g. for reaching high resolution with low bitrate (e.g. in case of performing status of the communication link), the bitlength being higher thin in the first low resolution encoding/decoding mode.

It is noted, however, that the selection 353 and 553 is not necessarily between a high resolution mode and a low resolution mode. In some examples, the different, selectable codebooks 357C1 and 357C2 may be directed to different applications and/or to different audio signals 1. For example, it may be that the first encoding/decoding mode is selected for a voiced frame and the second encoding/decoding mode is selected for a unvoiced frame as determined by the result 360c of the classification 360 (FIG. 5c). In this case, it may be that there is not a different resolution/quality vs different bitrate, but simply different codebooks, one more appropriate than the other.

FIG. 2e shows another way of operating for the encoder 2 (2b, 2c). Here, the first latent representation 330 (469) is provided to the quantization module 300 (here indicated with 300e). In this case, the both a first encoding mode 341′ and a second encoding mode 342′ may be performed in parallel. The first encoding mode 341′ may output a first coded signal 3′ and the second encoding mode 342′ may output a second coding signal 3″. Subsequently, the first coded signal 3′ may be redecoded at block 341e′, to obtain a first redecoded version 1′ of the input audio signal 1, while the second coded signal 3″ may be redecoded at block 341e″, to obtain a second redecoded version 1″ of the input audio signal 1. A selection at block 353e may be based on a comparison, e.g. by comparing the original version 1 of the input audio signal with the first redecoded version 1′ and the second redecoded version 1″, in such a way to determine a first distortion metrics indicative of the distortion of the first redecoded version 1′ from the original audio signal 1, and a second distortion metrics indicative of the distortion of the second redecoded version 1″ from the original audio signal 1, and by further comparing the first distortion metrics with the second distortion metrics. The mode that minimizes the distortion is selected, as shown by the switch 353e′: the coded signal 3 to be actually provided into the bitstream will therefore be, among the coded signals 3′ and 3″, the one that minimizes the distortion from the original audio signal 1. Instead of the coded version 3, the same may be performed with the versions formed by the indexes (indicated with 556′ and 556″) upstream to the coded signal writer 360. Advantageously, the technique of performing the two modes 341′ and 342″ in parallel (or more than two modes in parallel in other examples) does not need to be performed at the decoder.

Instead of comparing the first and second redecoded version 1′ and 1″ of the input audio signal 1, with the input audio signal 1, the example of FIG. 2e may be configured to perform in parallel both the first encoding mode (341′) to provide a first coded signal version (3′) and the second encoding mode (341″) to provide a second coded signal version (3″), but selecting between the first encoding mode and the second encoding mode by choosing to write, in the coded signal 3, the coded signal version (3′, 3″), out of the first and the second coded signal versions (3′, 3″), which maximizes processing efficiency (e.g. which minimizes computational consumption).

In FIG. 2d there is shown an example of an encoder (which may be, in some examples, one of 2, 2b or 2c) which can select between a first encoding mode 341 and a second encoding mode 342. Hereby, encoding mode 341 represents a combination of at least one scalar quantizer (355), mapping a single latent channel-wise scalar value (351S) to a latent channel-wise index (356) and at least one vector quantizer (355S), mapping a subset of all latent channel-wise scalar values (351S) to a single index (356S). Even if not shown in the figures, dually there may be present a decoder (which may be, in some examples, the decoder 10) which can select between a first decoding mode (e.g. corresponding to the first encoding mode 341) and a second decoding mode (e.g. corresponding to the second encoding mode 342). Different modes may be, for example, controlled by the bitrate, e.g. to adapt to the connection state (e.g. a busy connection state implying a low bitrate, in turn requiring the use of the first encoding mode, while a less busy connection state could imply a higher bitrate, in turn requiring the use of the second encoding mode).

In the example of FIG. 2d, in the first, low-quantizers-number, encoding mode 341 there are (e.g. for each frame, or for each latent representation) less quantizers than in the second encoding mode 342. For example, in the first encoding mode 341 there is at least one vector quantizer 355S which quantizes a vector formed by at least two scalar values (e.g. a first scalar value 351S′ and a second scalar value 351S′), onto one single index 356S, while in the second encoding mode 342 each of the first scalar value 351S′ and the second scalar value 351S″ is quantized independently from, respectively, a scalar quantizer 355′ and 355″, to provide two independent indexes 355′ and 355″, respectively. Dually, at the decoder, in the first, low-quantization-index-converter-number, decoding mode there are (e.g. for each frame, or for each latent representation) less quantization index converters than in the second, high-quantization-index-converter-number, decoding mode. For example, in the first decoding mode there is at least one quantization index converter which converts at least one single index 556 onto at least two scalar values, while in the second decoding mode there are two indexes which are mapped onto the at least two scalar values.

In several examples, it may be assumed that the length (e.g. time length) of the indexes 356, 356S is fixed (e.g., all the indexes 356, 356S requiring the same number of bits, or of other symbols written in the coded signal 3) or that the length of the indexes is variable (e.g., some indexes having a lower length in terms of their bitstream representation than other indexes). For example, the index 356S (generated in the first encoding mode 341) may have a shorter representation in the bitstream (coded signal) 3 than the two indexes 356′, 356″ which would be necessary in the second encoding mode 342. For this reason, in the first encoding mode 341 the length of the coded signal 3 is reduced, and this is advantageous for example in case of low bitrate requested (e.g. when the transmission channel is noisy), while the second encoding mode 342 permits to have a better resolution (because the codebook provides more indexes), but with increased payload and with increased consumption of computational power. Therefore, in the example of FIG. 2d both the encoder and the decoder may better adapt to the characteristics of the communication link.

In the example of FIG. 2d, the selection may be understood as a selection between a first, vectorial (or at least partially vectorial) mode (with at least one vectorial quantizer 355S), and a second scalar mode, with all scalar quantizers 355 for a same frame.

It is to be noted that, in parallel, the encoder and/or the decoder may select between at least a second, high-index-number, encoding mode and a first, low-index-number, encoding mode. In the second, high-index-number, encoding mode, at least one codebook with a higher number of indexes may be used, with higher resolution, and/or with higher bitlength (at least on average, e.g. at least for the majority of the indexes or at least for the most frequent indexes) than in the first, low-index-number, encoding mode. An example may be provided by FIG. 2d: the second, high-index-number, encoding mode is represented by the second mode 342, while the first, low-index-number, encoding mode is represented by the first mode 341 (and in fact there are less encoded indexes the second mode 342 than in the first mode 341, because in the first mode 341 only one index 365S is generated from multiple scalar values 351S′ and 351S″, while in the second mode 342 there is a greater number of quantizers 355, each providing exactly one index, therefore providing more indexes than in the first mode 341). However, in another example, even without any vectorial quantizer, a first, low-index-number, encoding mode may be embodied by causing the second learnable section to generate in the first mode less scalar values 351 than in the second mode. Dually, at the decoder 10 even without any vector quantizer processing multiple scalar values, a first, low-index-number, decoding mode may be embodied by providing to the first learnable section 510 in the first mode less scalar values 551 than in the second mode. It is to be noted that, in general terms, by reducing the number of indexes resolution is also reduced. However, the first, low-index-number, encoding (or decoding) mode permits to reduce the length of the coded signal 3, thereby adapting to a badly performing communication link, while the second, high-index-number, encoding (or decoding) mode permits to increase the quality e.g. in case of communication link being satisfactory.

FIGS. 7a and 7b show examples of multi-stage (residual) quantizations and multistage (residual) inverse quantizations, respectively.

FIG. 7a shows an example of multistage (residual) quantization that can be applied to the encoder 2 (e.g. 2b, 2c). In particular one residual quantizer 355R (which may be an instantiation of any of the quantizers 355 discussed above) is shown, but the other residual quantizers (e.g. in the number N2) are, in one example, the same of the residual quantizer 355R. The residual quantizer 355R may include, in particular, a series with at least two subquantizers, e.g. a base subquantizer (first subquantizer) 355R1 and a residual subquantizer (second subquantizer) 355R2, but in some example there are more than two subquantizers. Here, the latent scalar value (latent channel) 351, outputted by the second learnable section 350, may be inputted into the base subquantizer (first subquantizer) 355R1. A first index (base index) 356R1 is therefore obtained, and may therefore be encapsulated into the coded signal 3 (or, in the example of FIG. 2e, in the version 3′ or 3″). Then, the first index (base index) 356R1 may be inputted into an inverse quantizer (quantization index converter) 555R1 (which substantially simulates a quantization index converter at the decoder). Then, an inversely quantized version 551R1 of the first index 356R1 is generated by the inverse quantizer (quantization index converter) 555R1. The inversely quantized version 551R1 of the first index 356R1 therefore represents a simulation of how the decoder will dequantize the latent scalar value 351. Then, the latent scalar value 351 is compared with the inversely quantized version 551R1 of the first index 356R1 at the comparison block 353R1, thereby providing a first residual latent scalar value 351R1, which represents the quantization error impairing the inversely quantized version 551R1 of the first index 356R1. Then, the first residual latent scalar value 351R1 may be inputted into the second subquantizer 355R2, to obtain a second index (residual index) 356R2, which also may be encapsulated into the coded signal 3 (or, in the example of FIG. 2e, in the version 3′ or 3″). The inverse subquantizer 555R2 and the second comparison block 353R2 can be avoided in case only the first index 355R1 and the second index 355R2 are to be provided; otherwise, the inverse subquantizer 555R2 and the second comparison block 353R2 can be used (analogously to the inverse subquantizer 555R1 and the first comparison block 353R1) to obtain a third index from a second residual value 351R2.

FIG. 7b shows an example of a multistage (residual) dequantization (inverse quantization) at the decoder 10 (e.g. 10b, 10c), in particular showing two quantization index converters 555R (which may be examples of the quantization index converters 555 of FIGS. 3a-3c). Here, the coded signal reader 560 provides both the first index (base index) 556R1 (corresponding to the first index 356R1 of FIG. 7a) and the second index (residual index) 556R2 (corresponding to the second, residual index 356R2 of FIG. 7a). Then, both the indexes 556R1 and 556R2 are inversely quantized at two respective dequantizer instantiations 555R1′ and 555R2′, so as to obtain a first component (base component) 551′R1 and a second component (residual component) 551′R2 of the dequantized latent scalar value 551 to be obtained. Then in a additional block 553R the first component (base component) 551′R1 and the second component (residual component) 551′R2 are added with each other, to obtain the dequantized latent scalar value 551, being part of the dequantized first latent representation 550 to be inputted in the first learnable section 540.

Even if not shown in FIGS. 7a and 7b, it is intended that each of the subquantizers 355R1, 355R2, and the inverse subquantizers 555R1, 555R2, 555R1′, and 555R2′ makes use of a codebook. The codebook may be the same for each quantization step (or respectively for each inverse quantization step), or different codebooks may be used (for example, a base codebook may be used for the first subquantizer 355R1, and a different, residual codebook may be used for the second, residual subquantizer 355R2. The same may apply to the inverse subquantizers.

It is also possible to select (353, 553) the operation of the encoder and the decoder of FIGS. 7a and 7b according to at least a first mode and a second mode (further selectable modes are possible in examples). For example:
in the first, non-residual mode, the encoder simply generates one single index 356 for each latent scalar value 351, and the decoder simply uses the single index 356 (in its decoder-side version 556) to generate one single dequantized latent scalar value 556;
in the second, residual mode, the encoder (like in FIG. 7a) generates the first, base index 356R1 and at least one second, residual index 356R2 for each latent scalar value 351, and the decoder (like in FIG. 7b) uses the first, base index 356R1 (in the decoder-side version 556R1) to generate the first component 551R1′ and at least one second, residual index 356R2 (in the decoder-side version 556R2) to generate the second component 551R2′.

In general terms, the first, non-residual mode may reach a lower quality (e.g. lower resolution) but with low bitrate, while the second, residual mode, may reach a higher quality, but necessitating of high bitrate. The selection 353 between the first, non-residual mode and the second, residual mode, may be carried out, at the encoder, by one of the techniques illustrated in FIGS. 5a-5c, while at the decoder the selection may be performed based on signalling in the coded signal 3, like in FIG. 7a. In examples, the selection (353, 553) may be between at least a first residual mode with a lower level of residual quantization steps and at least a second residual mode with a higher level of residual quantizations.

Summarizing, selections may be between at least two (but also more than two in some examples) encoding/decoding modes. It may be that at least one (e.g. some of, all of) the following statements apply:
1) The first mode is a first, low-quantizers-number, mode (341, 342) and the second encoding mode is a second, high-quantizers-number, mode (341, 342), e.g. because the numbers (N2′, N2″) of latent scalar values (latent channels) varies between the first mode and the second mode (like in FIG. 2b), or because the first mode is an at-least-partially-vectorial mode (like in FIG. 2d) and the second mode is a scalar-mode (like in FIG. 2d);
2) The first mode uses at least one first codebook, and the second mode uses at least one second codebook, with different resolution, bitlength and/or number of indexes (see FIG. 2c);
3) The first mode is a low-index-number, mode (341, 342) and the second mode is a high-index-number mode, like in FIGS. 2c and 2d;
4) The first mode is a first, reduced-latent mode, while the second mode is a second, increased latent mode;
5) The first mode is a base mode (single-stage mode), and the second mode is a residual mode (multi-stage mode, like in FIGS. 7a and 7b), or the first mode is multi-stage but has a first number of stages which is smaller than the second number of stages in the second mode
6) at the encoder only, it may be possible to perform in parallel both the first encoding mode and the second encoding mode, to then select between the first and second encoding mode by choosing to write, in the coded signal 3, the coded signal version which minimizes the distortion
7) The first mode may provide higher resolution than the second mode
8) One mode may be a classification mode directed to a particular class, e.g. directed to a voiced class, while another mode may be a classification mode, e.g. directed to an unvoiced class.

The statements above may be combined with each other in different combinations.

The modes may be chosen through a criterion which may involve at least one of a selection (like in FIG. 5a), a channel state measurement (like in FIG. 5b), and a signal classification (like in FIG. 5c).

As explained above, a latent representation (e.g., 330, 350, 530, 550, etc.) may expressed in terms of matrix (e.g., M×N matrix), where M may be the number of latent channels and N may be the length of one frame. In general terms, when it is explained that different encoding/decoding modes are selected, the examples are based on the frame: for example, the low-index-number mode and the high-index-number mode have different numbers of indexes for each frame; the first, low-quantizers-number, mode and the second, high-quantizers-number, mode, have different numbers of quantizers for each frame, and so on.

### Discussion

Model: An inventive model may include a (not necessarily symmetric) pair of convolutive encoder (e.g. 2, such as 2b or 2c) and decoder (e.g. 10, such as 10b or 10c) and a quantization module (e.g. 300, 313). The encoder may transform the first latent representation 330 to a (usually) lower-dimensional representation 350 that is inputted to the plurality of quantizers 355. Each quantizer 355 approximates each element (latent scalar value, latent channel) 351 of the latent vector independently e.g. by the closest match from a set of candidate values (e.g. stored in the codebook). This set of candidate values may be learned or may be chosen fixed. The indices 356 of the candidate values per latent dimension are stored or transmitted to the receiver (e.g. decoder 10, such as 10b or 10c) which reconstructs the corresponding quantizer input vector from it. The (e.g. convolutive) decoder may reconstruct the latent (e.g. in its versions 550 and 530) which is then used for reconstructing the input signal 16 by the NAC decoder 520.

Training: The SQ 300 (313) may be trained by approximating each quantizer 355 by an identity in the backward path and enforcing the quantizer structure by an additional loss or by simulating the effects of the quantizer by adding uniform noise per latent dimension scaled to match the target quantization resolution. In both cases, the intermediate (second) representation 350 of the SQ module may be quantized elementwise during inference.

Scalability: Data rate can be traded off against signal quality e.g. by reducing the quantizer resolution of a pretrained NAC during inference or by training a new SQ for a pretrained NAC. Here, the corresponding pretrained SQ module 300 (313) may be approximated by a weaker SQ providing a NAC working at a lower data rate by only retraining the SQ in a student-teacher approach by minimizing a simple (e.g., MSE or MAE-based) loss measuring the difference between the outputs of student and teacher.

### Benefits From the Proposed Technique (Inference)

1. The SQ module 300 (313) allows for latent representations 350 which are order of magnitudes smaller than the ones of traditional VQs providing comparable quality. Thereby the overall design of the NAC encoder (first learnable section) 20 can be done with less parameters and more computationally efficiency.
2. The discrete representation learned by an SQ 300 (313) is easy to interpret as an approximation of the latent as the distances between the latent representation and the SQ approximation are computed between scalars.
3. Quantization can be realized very efficiently by integer casting or other efficient methods.
4. The SQ module 300 (313) also works with a fixed codebook.
5. During inference different SQ modules (e.g. instantiating different encoding/decoding modes) can be used differing in the number and distribution of coding levels and/or encoder/decoder pairs allowing for different number of dimensions in the latent. This yields an easy and efficient way to trade off data rate against quality. There is also no need for storing several complete NACs corresponding to different data rates but just a single NAC and several (tiny) SQ models.
6. A single SQ module 300 (313) is sufficient, while most VQ approaches have to rely on residual quantization.

### Benefits From the Proposed Technique (Training)

1. Strategies that enable scalability have been proposed for SQ (see above). These techniques avoid the costly retraining of the complete NAC (on the order of several weeks on a large GPU) and only require the retraining of the SQ module 300 and/or 500 (on the order of a few hours on a small GPU) or just the adjustment of quantizer levels.
2. No additional mechanisms for training a codebook are needed.
3. Robust training methods, i.e., straight-through and noise-based training.
4. The convergence speed of the proposed quantization technique is faster than competing VQ approaches.

### Applications and Benefits From the Invention

Computationally efficient speech coding
Scalable speech coding
Storage-efficient speech coding
Potentially better quality at larger data rates (to be validated)

### Aspects Extremely Important for Inference (Not in “Patent Style” for Readability)

1. Efficient quantization by integer casting
2. Scalability w.r.t. quantizer resolution
3. Scalability w.r.t. dimensions by switching retrained SQs

### Aspects Extremely Important for Training

1. Training the SQ by approximation of the quantizer by appropriately scaled uniformly distributed white noise
2. Training the SQ by straight-through approximation, i.e., approximating the quantizer by an identity and an additional loss
3. Training the SQ by approximating the quantizer by a smooth surrogate (Softmax)
4. Training a codebook by moving average
5. Training a codebook by backpropagation
6. Training a residual codebook
7. Training a dictionary of codebooks
8. Retraining the SQ of pretrained NACs

### Choosing Data Rate by Switching Between Scalar Quantizer (SQ) Modules

Training: For all following data rate adjustment options, the NAC Encoder/Decoder (20, 520) and SQ Encoder/Decoder (300, 500) is trained together with an SQ with a certain distribution of Codebook Levels (CLs) (user-defined and fixed or learnable).

Inference: For all of the following options the trained SQ module 300 (313) comprising NAC Encoder/Decoder (20, 520) and SQ Encoder/Decoder (300, 500) or a part of it is replaced by a user defined or retrained surrogate that enables a different transmission data rate of the NAC 20 and/or 520.
1) Adjusting user-defined CLs (parameterizing the quantizers 355) of trained Neural Audio Coder (NAC) during application
   a) A certain number of CLs, parameterizing the quantizers 355, of the SQ module 300 (313) is chosen by the user with a certain distribution (e.g., uniform or with higher resolution for smaller values).
   b) A certain number of CLs, parameterizing the quantizers 355, of the SQ module 300 (313) is trained while keeping NAC Encoder/Decoder (20, 520) and SQ Encoder/Decoder (300, 500) fixed. During application the application/user can switch between these trained codebooks.
   c) Option a) and b) can be applied globally (one codebook for all latent channels) or latent-channel-wise (a different codebook per latent channel). The resolution may be equal for all latent channels or may differ (providing better resolution to more important channels and vice versa).
2) Switching between retrained SQ modules comprising SQ Encoder/Decoder and SQ
   a) Train a new SQ Encoder/Decoder pair (340, 540) e.g. with a bottleneck dimension potentially different to the one in NAC Training together with an SQ (deterministic or trained) comprising a user-defined number of CLs. Combine the NAC Encoder/Decoder (20, 520) with different retrained SQ modules 300 (313) during application.
   b) Perform 2a) and then apply methods 1a)-1c), i.e., keep the NAC Encoder/Decoder (20, 520) and the SQ Encoder/Decoder (300, 500) from 2a) fixed and only readjust the CLs of the SQ.

Non-limitative examples of particular parts of the examples above are exemplified below.

### Examples of Some Features

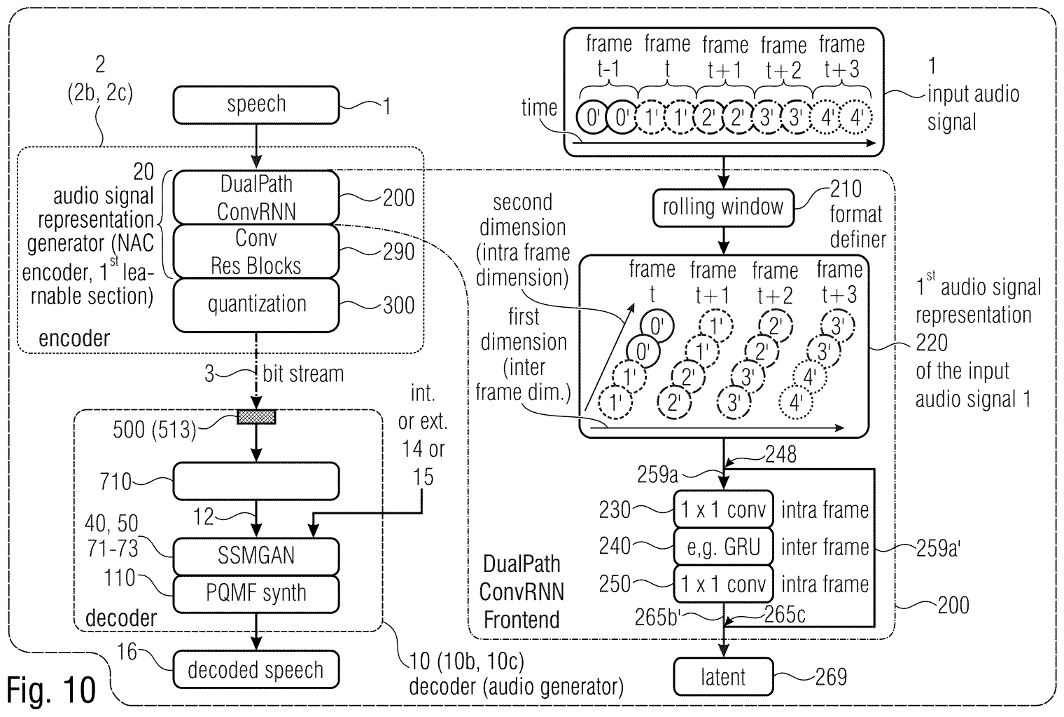

FIG. 10 shows an example of a vocoder (or more in general, a system for processing audio signals) system. The vocoder system may include, for example, the encoder 2 (e.g. 2b, 2c) and/or the decoder 10 (e.g. 10b, 10c). The encoder 2 may include, as explained above, the first encoder-side learnable layer (NAC encoder) 20, also called audio signal representation generator, to generate the first latent representation (audio signal representation) 330 (469) of the input audio signal 1. The input audio signal 1 may be processed by the first encoded-side learnable layer 20. The first latent representation 330 of the input audio signal 1 may be either stored (and e.g., used for purposes like processing of the audio signal) or may be quantized (e.g., through a quantizer 300), so as to obtain a bitstream 3. A decoder 10 (audio generator) may read the bitstream 3 and generate an output audio signal 16.

Each of the first encoded-side learnable layer 20, the encoder 2, and/or the decoder 10 may be a learnable system and may include at least one learnable layer and/or learnable block.

The input audio signal 1 (which may be obtained, for example, from a microphone or can be obtained from other sources, such as a storage unit and/or a synthesizer) may be of the type having a sequence of audio signal frames. For example, the different input audio signal frames may represent the sound in a fixed time length (e.g., 10 ms or milliseconds, but in other examples, different lengths may be defined, eg., 5 ms and/or 20 ms). Each input audio signal frame may include a sequence of samples (for example, at 16 kHz or kilohertz and there would be 160 samples in each frame). In this case, the input audio signal is in the time domain, but in other cases, it could be in the frequency domain. The input audio signal 1 may be provided to a learnable block 200, which may be part of the first learnable section). The learnable block 200 may be of the type having a Dual Path (e.g. coping with at least one residual). The learnable block 200 may provide a processed version 269 of the input audio signal 1 onto a second learnable block 290 (this may be avoided in some cases). Subsequently, the learnable block 200 or the learnable block 290 may provide its outputted processed version of the input audio signal 1 to the quantization module 300. The quantization module 300 may provide the coded signal (bitstream) 3. It will be seen that the quantization module 300 may be a learnable quantization module.

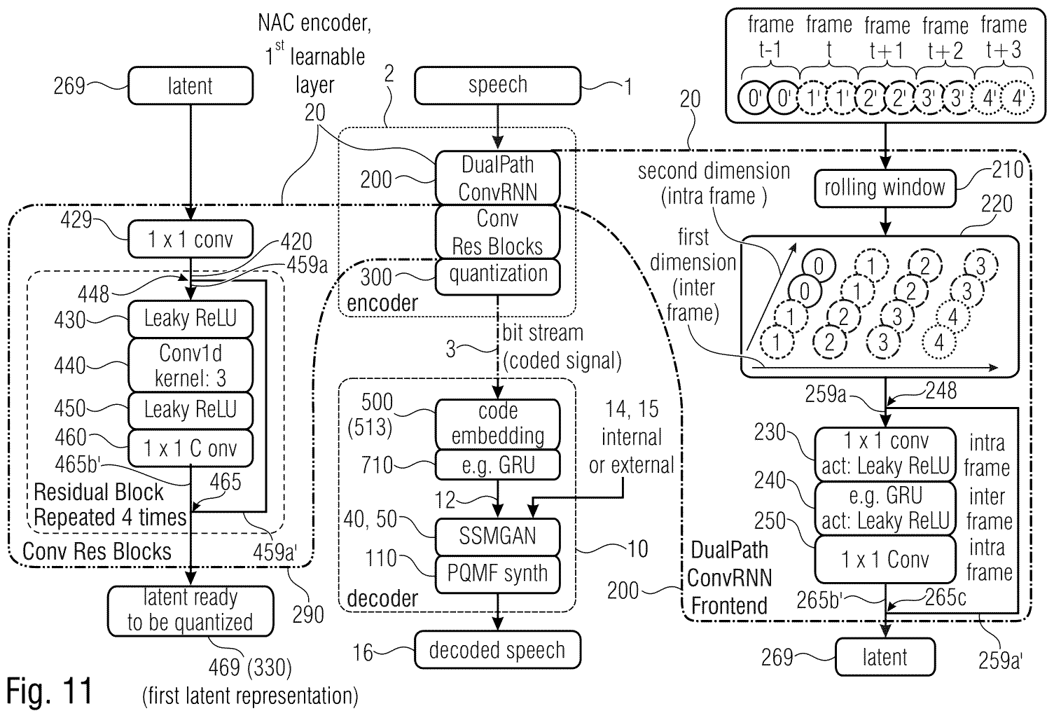

The learnable block 200 may process the input audio signal 1 (in one of its processed versions) after having converted the input audio signal 1 (or a processed version thereof) onto a multi-dimension representation. A format definer 210 may therefore be used. The format definer 210 may be a deterministic block (e.g., a non-learnable block). Downstream to the format definer 210, the processed version 220 outputted by the format definer 210 (also called first audio signal representation of the input audio signal 1) may be processed through at least one learnable layer (e.g., 230, 240, 250, 290). At least the learnable layer(s) which is (are) internal to the learnable block 200 (e.g., layers 230, 240, 250) are learnable layers which process the first audio signal representation 220 of the input audio signal 1 in its multi-dimensional version (e.g., bi-dimensional version). As will be shown, this may be obtained, for example, through a rolling window, which moves along the single dimension (time domain) of the input audio signal 1 and generates a multi-dimensional version 220 of the input audio signal 1. As can be seen, the first audio signal representation 220 of the input audio signal 1 may have a first dimension (inter frame dimension), so that a plurality of mutually subsequent frames (e.g., immediately subsequent to one with respect to each other) is ordered according to (along) first dimension. It is also to be noted that the second dimension (intra frame dimension) is such that the samples of each frame are ordered according to (along) the second dimension. As can be seen in FIG. 10 or 11, the frame t may be, in some examples, then organized with the two samples 0′ and 0′ along the second direction (inter frame direction). As can be seen, this sequence of frames t, t+1, t+2, t+3, etc. may be respected along the first dimension while in the second dimension the sequence of samples is also respected for each frame. The format definer 210 may be configured to insert, along the second dimension [e.g. intra frame dimension] of the first multidimensional audio signal representation of the input audio signal, input audio signal samples of each given frame. The format definer 210 may be, additionally or in alternative, configured to insert, along the second dimension [e.g. intra frame dimension] of the first multi-dimensional audio signal representation 220 of the input audio signal 1, additional input audio signal samples of one or more additional frames immediately successive to the given frame [e.g. in a predefined number, e.g. application specific, e.g. defined by a user or an application]. The format definer 210 is configured to insert, along the second dimension of the first multidimensional audio signal representation 220 of the input audio signal 1, additional input audio signal samples of one or more additional frames immediately preceding the given frame [e.g. in a predefined number, e.g. application specific, e.g. defined by a user or an application]. However, in some examples, this is not necessary, insertions of samples from other frames may be avoided.

Downstream to the format definer 210, at least one learnable layer (230, 240, 250) may be inputted by the audio signal representation 220 of the input audio signal 1. Notably, in this case, the at least one learnable layer 230, 240, and 250 may follow a residual technique. For example, at point 248, there may be a generation of a residual value from the audio signal representation 220. In particular, the audio signal representation 220 may be subdivided among a main portion 259a′ and a residual portion 259a of the audio signal representation 220 of the input audio signal. The main portion 259a′ of the audio signal representation 220 may therefore not be subjected to any processing up to point 265c in which the main portion 259a′ of the audio signal representation 220 is added to (summed with) a processed residual version 265b′ outputted by the at least one learnable layer 230, 240, and 250 e.g. in cascade with each other. Accordingly, a processed version 269 of the input audio signal 1 may be obtained.

The at least one residual learnable layer 230, 240, 250 may include at least one of:
an optional first learnable layer (230), e.g. a first convolutional learnable layer, which is a convolutional learnable layer configured to generate a second multi-dimensional audio signal representation of the input audio signal (1) by sliding along a second direction [e.g. intra frame direction] of the first multi-dimensional audio signal representation (220) of the input audio signal (1);]
a second learnable layer (240) which may be a recurrent learnable layer (e.g. a gated recurrent learnable layer) configured to generate a third multi-dimensional audio signal representation of the input audio signal (1) by operating along the first direction [e.g. inter frame direction] of the second multi-dimensional audio signal representation (220) of the input audio signal (1) [e.g. using a 1×1 kernel, e.g. a 1×1 learnable kernel, or another kernel, e.g. another learnable kernel];
a third learnable layer (250) [which may be, for example, a second convolutional learnable layer] which is a convolutional learnable layer configured to generate a fourth multi-dimensional audio signal representation (265b′) of the input audio signal by sliding along the second direction [e.g. intra frame direction] of the first multi-dimensional audio signal representation of the input audio signal [e.g. using a 1×1 kernel, e.g. a 1×1 learnable kernel].

Notably, the first learnable layer 230 may be a first convolutional learnable layer. It may have a 1×1 kernel. The 1×1 kernel may be applied by sliding the kernel along the second dimension (i.e., for each frame). The recurrent learnable layer 240 (e.g., gated recurrent unit, GRU) may be inputted with the output from the first convolutional learnable layer 230. The recurrent learnable layer (e.g., GRU) may be applied in the first dimension (i.e., by sliding from frame t, to frame t+1, to frame t+2, and so on). As it will be explained later, in the recurrent learnable layer 240, each value of the output for each frame may also be based on the preceding frames (e.g., the immediately preceding frame, or also a number n of frames immediately before the particular frame; for example, for the output of the recurrent learnable layer 240 for frame t+3 in the case of n=2, then the output will take into consideration the values of the samples for the frame t+1 and for the frame t+2, but the values of the samples of frame t will not be taken into consideration). The processed version of the input audio signal 1 as outputted by the recurrent learnable layer 240 may be provided to a second convolution learnable layer (third learnable layer) 250. The second convolutional learnable layer 250 may have a kernel (e.g., 1×1 kernel) which slides along the second dimension for each frame (along the second, intra frame dimension). The output 265b′ of the second convolutional learnable layer 250 may then be added, e.g. at point 265c with the main portion 259a′ of the audio signal representation 220 of the input audio signal 1, which has bypassed the learnable layers 230, 240, and 250.

Then, a processed version 269 of the input audio signal 1 may be provided (as latent 269) to the at least one learnable block 290. The at least one convolutional learnable block 290 may provide a version of e.g., 256 samples (even though different numbers may be used, such as 128, 516, and so on).

As shown in FIG. 11 (which may be seen as an instantiation of FIG. 11), the at least one convolutional learnable block 290 may include a convolutional learnable layer 429, to perform a convolution (e.g. using a 1×1 kernel) onto the signal (latent) 269 (e.g., as outputted by the learnable block 200). The convolutional learnable layer 429 may be a non-residual learnable layer. The convolutional learnable layer 429 may output a convoluted version 420 of the signal 269 and may also be a processed versions of the input audio signal 1.

The at least one convolutional learnable block 290 may include at least one residual learnable layer. The at least one convolutional learnable block 290 may include at least one learnable layer(s) (e.g. 440, 460). The learnable layer(s) 440, 460 (or at least one or some of them) may follow a residual technique. For example, at point 448, there may be a generation of a residual value from the audio signal representation or latent representation 269 (or its convoluted version 420). In particular, the audio signal representation 420 may be subdivided among a main portion 459a′ and a residual portion 459a of the audio signal representation 420 of the input audio signal 1. The main portion 459a′ of the audio signal representation 420 of the input audio signal 1 may therefore not be subjected to any processing up to point 465 in which the main portion 459a′ audio signal representation 420 of the input audio signal 1 is added to (summed with) a processed residual version 465b′ outputted by the at least one learnable layer 440 and 460 in cascade with each other. Accordingly, the latent representation 469 (330) of the input audio signal 1 may be obtained, and may represent the output of the first learnable section 20 (audio representation generator).

The at least one residual learnable layer in at least one convolutional learnable block 290 may include at least one of:
a first layer (430), configured to generate a residual multi-dimensional audio signal representation of the input audio signal (1) from the audio signal representation 420 (the first l layer 430 may be an activation function, e.g. a Leaky ReLu, see below);
a second, learnable layer (440) which is a convolutional learnable layer configured to generate a residual multi-dimensional audio signal representation of the input audio signal 1 by convolution [e.g. a kernel 3 may be used] from the audio signal representation outputted by the first learnable layer (430);
a third layer (450) to generate a residual multi-dimensional audio signal representation of the input audio signal 1 from audio signal representation outputted by the second learnable layer (440) (the learnable layer 450 may be an activation function, e.g. a Leaky ReLu, see below);
a fourth, learnable layer (460) which is a convolutional learnable layer configured to generate a residual multi-dimensional audio signal representation 456b′ of the input audio signal 1 by convolution [e.g. a kernel 1×1 may be used] from the residual multi-dimensional audio signal representation of the input audio signal 1 outputted by the third learnable layer (450).

The output 465b′ of the second convolutional learnable layer 460 (fourth learnable layer) may then be added to, at point 465, (summed with) the main portion 459a′ of the audio signal representation 420 (or 269) of the input audio signal 1, which has bypassed the layers 430, 440, 450, 460.

It is to be noted that the output 469 (330) may be considered the first latent representation outputted by the first encoded-side learnable layer 20 (e.g. in FIGS. 1a-1c).

Subsequently, the quantization module 300 may be provided in case it is necessary to write a coded signal 3. The quantization module 300 may be a learnable quantization module [e.g. a quantization module using at least one learnable codebook], which is discussed in detail above. The quantization module (e.g. the learnable quantization module) 300 may associate, to each frame of the latent representation (e.g. 220 or 469) of the input audio signal (1), or a processed version of the first multi-dimensional audio signal representation, index(es) of at least one codebook, so as to generate the coded signal 3 [the at least one codebook may be, for example, a learnable codebook].

Notably, the cascade formed by the learnable layers 230, 240, 250 and/or the cascade formed by layers 430, 440, 450, 460 may include more or less layers, and different choices may be made. Notably, however, they are residual learnable layers, and they are bypassed by the main portion 259′ of the audio signal representation 220.

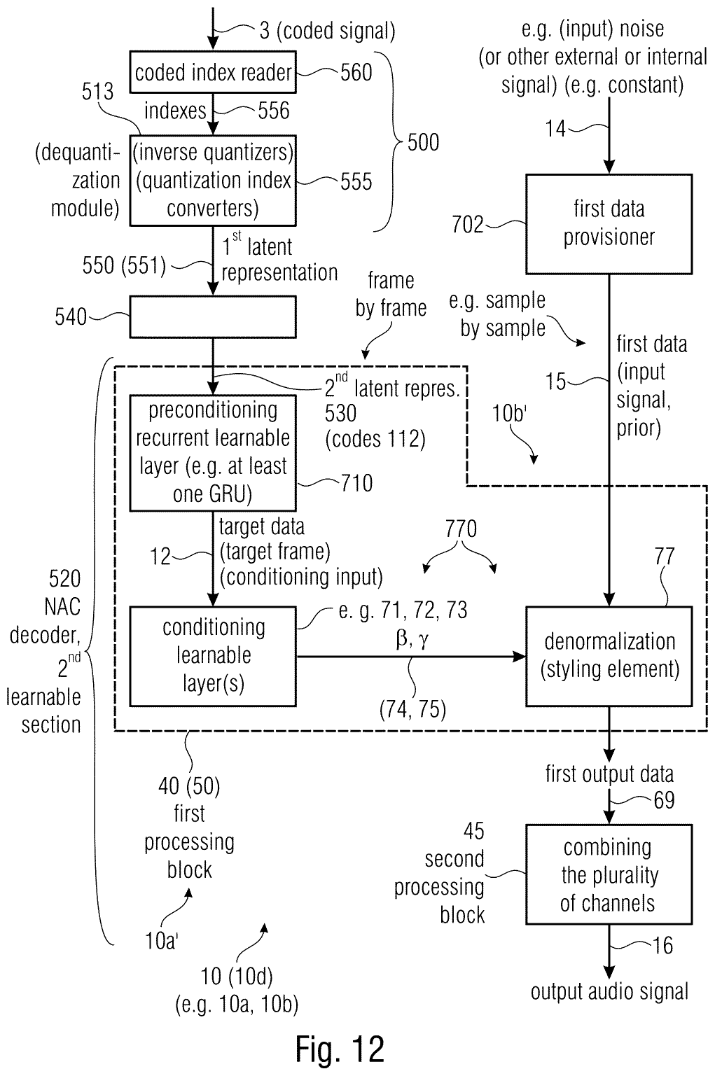

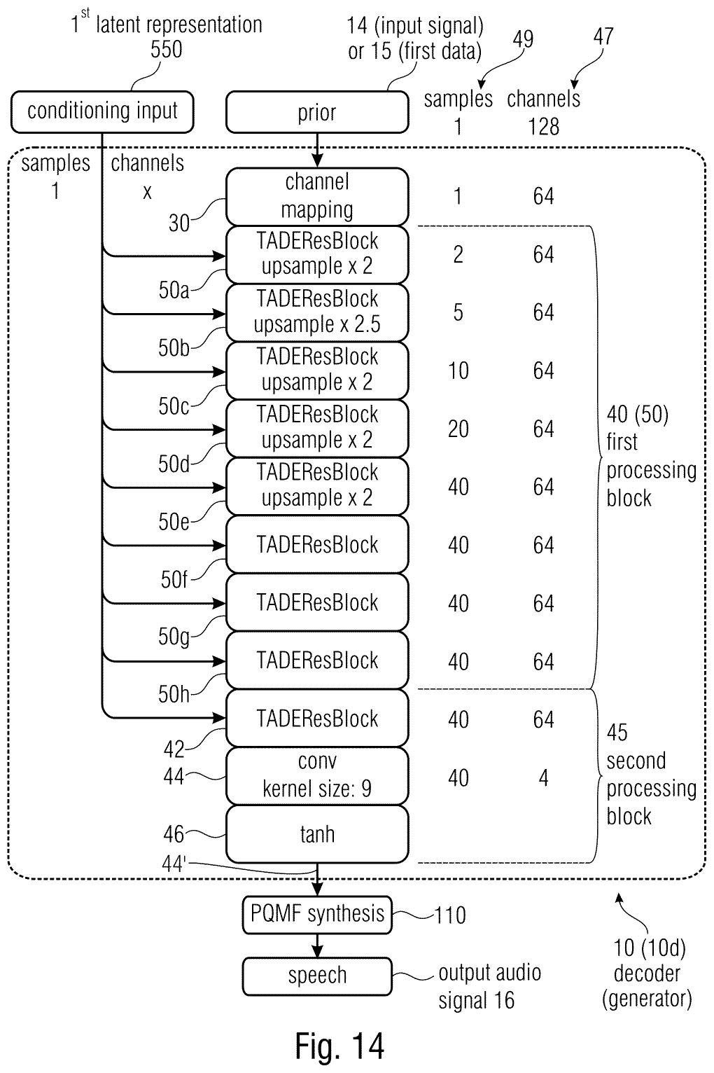

FIG. 12 shows an example of how the decoder (audio generator) 10 (e.g. 10b, 10c) of FIGS. 3a-3c could be (but different examples could be used), and is therefore indicated with 10d. The coded signal 3 may comprise frames (e.g. encoded as indexes, e.g. encoded by the encoder 2, e.g. after quantization by the quantization module 300). The output audio signal 16 may be obtained. The decoder 10 (10d) may include a first data provisioner 702. The first data provisioner 702 may be inputted with an input signal (input data) 14 (e.g. from an internal source, e.g. a noise generator or a storage unit, or from an external source e.g. an external noise generator or an external storage unit or even data obtained from the coded signal 3). The input signal 14 may be noise, e.g. white noise, or a deterministic value (e.g. a constant). The input signal 14 may have a plurality of channels (e.g. 128 channels, but other numbers of channels are possible, e.g. a number larger than 64). The first data provisioner 702 may output first data 15. The first data 15 may be noise, or taken from noise. The first data 15 may be inputted in at least one first processing block 50 (40). The first data 15 may be (e.g., when taken from noise, which therefore corresponds to the input signal 14) unrelated to the output audio signal 16, but in some cases they can be obtained from the coded signal 3, e.g. LPC parameters, or other parameters, taken from the coded signal 3; notably, an advantage of the present examples is that the first data 15 do not need to be explicit acoustic features, and the first data 15 may be more easily noise). The at least one first processing block 50 (40) may condition the first data 15 to obtain first output data 69, e.g. using a conditioning obtained by processing the coded signal 3. The first output data 69 may be provided to a second processing block 45. From the second processing block, an audio signal 16 may be obtained (e.g. through PQMF synthesis). The first output data 69 may be in a plurality of channels. The first output data 69 may be provided to the second processing block 45 which may combine the plurality of channels of the first output data 69 providing an output audio signal 16 in one signal channel (e.g. after the PQMF synthesis, e.g. indicated with 110 in FIGS. 14 and 10, but not shown in FIG. 12).

As explained above, the output audio signal 16 (as well as the original audio signal 1 and its encoded version, the coded signal 3 or its representation 20 or any other of its processed versions, such as 269, or the residual versions 259a and 265b′, or the main version 259a′, and any intermediate version outputted by layers 230, 240, 250, or any of the intermediate versions outputted by any of layers 429, 430, 440, 450, 460) are generally understood as being subdivided according to the sequence of frames (in some examples, the frames do not overlap with each other, while in some other examples they may overlap). Each frame may include a sequence of samples. For example, each frame may be subdivided into 16 samples (but other resolutions are possible). It is also noted that the multiple frames may be grouped in one single packet of the coded signal 3, e.g., for transmission or for storage. While the time length of one frame is in general considered fixed, the number of samples per frame may vary, and upsampling operations may be performed.

The decoder 10 (10d) may make use of:
a first branch (e.g. a frame-by-frame branch) 10a′, which may be updated for each frame, e.g. using the frames obtained from the coded signal 3 (e.g. the frame may be in form of indexes as quantized by the quantization module 300 and/or in form of codes (such as scalar, vectors) 112 (530), e.g. as converted from the dequantization module 500 (513), which is also said reverse quantization module or inverse quantization module); and/or
a second branch (e.g. a sample-by-sample branch) 10b′.

The second branch 10b′ may contain at least one of blocks 702, 77, and 69.

As shown by FIG. 12, indexes 556 may be obtained from the dequantization module 500 (513) to obtain a first (decoder-side) latent representation 550. The first latent representation 550 may be multi-dimensional (e.g. bidimensional, tridimensional, etc.). The dequantization module 500 (513) may include (e.g. be) learnable codebooks.

The sample-by-sample branch 10b′ may be updated for each sample e.g. at the output sampling rate and/or for each sample at a lower sampling-rate than the final output sampling-rate, e.g. using noise 14 or another input taken from an external or internal source.

A first processing block 40 may operate like a conditional neural network, for which data from the coded signal 3 (e.g. codes 112, 530) are provided for generating conditions which modify the input data 14 (input signal). The input data (input signal) 14 (in any of its evolutions) will be subjected to several processings, to arrive at the output audio signal 16, which is intended to be a version of the original input audio signal 1. Both the conditions, the input data (input signal) 14 and their subsequent processed versions may be represented as activation maps which are subjected to learnable layers, e.g. by convolutions. Notably, during its evolutions towards the speech 16, the signal 1 may be subjected to an upsampling (e.g. from one sample 49 to multiple samples, e.g. thousands of samples, in FIG. 14), but its number of channels 47 may be reduced (e.g. from 64 or 128 channels to 1 single channel in FIG. 14).

First data 15 may be obtained (e.g. the sample-by-sample branch 10b′), for example, from an input (such as noise or a signal from an external signal), or from other internal or external source(s). The first data 15 may be considered the input of the first processing block 40 and may be an evolution of the input signal 14 (or may be the input signal 14). Basically, the first data 15 is modified according to the conditions set by the first processing block 40 to obtain first output data 69. The first data 15 may be in multiple channels, e.g. in one single sample. Also, the first data 15 as provided to the first processing block 40 may have the one sample resolution, but in multiple channels. The multiple channels may form a set of parameters, which may be associated to the coded parameters encoded in the coded signal 3. In general terms, however, during the processing in the first processing block 40 the number of samples per frame increases from a first number to a second, higher number (i.e. the sampling rate, which is here also called bitrate, increases from a first sampling rate to a second, higher sampling rate). On the other side, the number of channels may be reduced from a first number of channels to a second, lower number of channels. The conditions used in the first processing block (which are discussed in detail below) can be indicated with 74 and 75 and are generated by target data 12, which in turn are generated from target data 12 obtained from the coded signal 3 (e.g. through the dequantization module 500, 513). It will be shown that also the conditions (conditioning feature parameters) 74 and 75, and/or the target data 12 may be subjected to upsampling, to conform (e.g. adapt) to the dimensions of the versions of the target data 12. The unit that provides the first data 15 (either from an internal source, an external source, the coded signal 3, etc.) is here called first data provisioner 702.

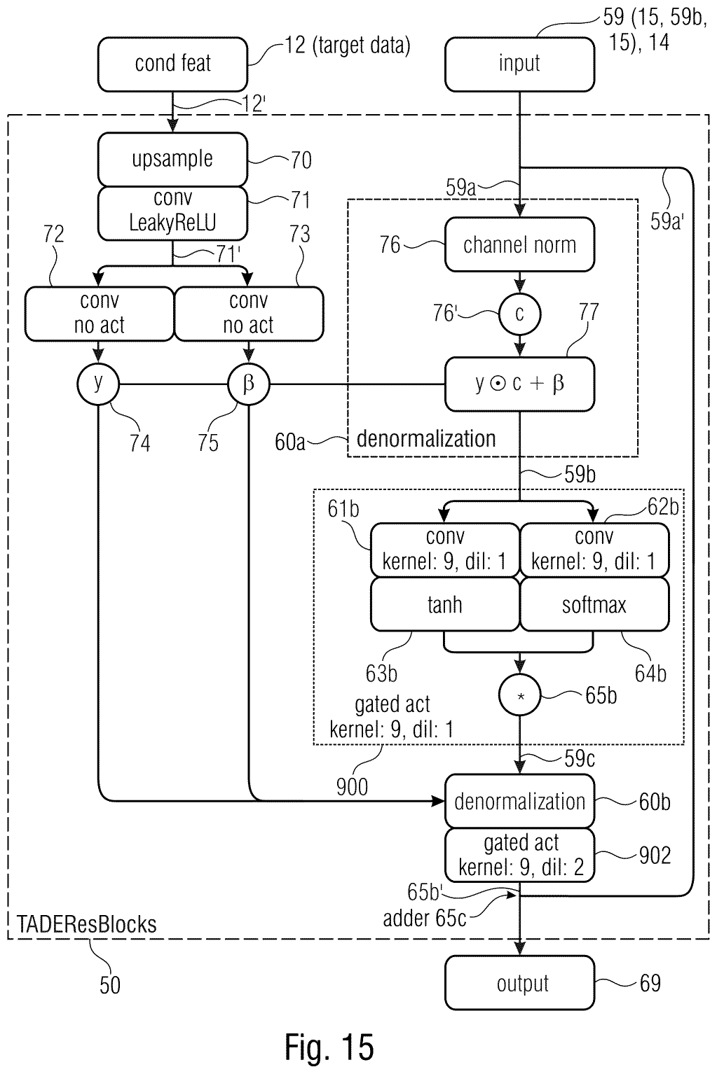

As can be seen from FIG. 12, the first processing block 40 may include a preconditioning learnable layer 710, which may be or comprise a recurrent learnable layer, e.g. a recurrent learnable neural network, e.g. a GRU, but this is not necessary. The preconditioning learnable layer 710 may generate target data 12 for each frame. The target data 12 may be at least 2-dimensional (e.g. multi-dimensional): there may be multiple samples for each frame in the second dimension and multiple channels for each frame in the first dimension. The target data 12 may be in the form of a spectrogram, which may be a mel-spectrogram (but this is not strictly necessary), e.g. in case the frequency scale is non-uniform and/or is motivated by perceptual principles. In case the sampling rate corresponding to conditioning learnable layer to be fed is different from the frame rate, the target data 12 may be the same for all the samples of the same frame e.g. at a layer sampling rate. Another up-sampling strategy can also be applied. The target data 12 may be provided to at least one conditioning learnable layer, which is here indicated as having the layer 71, 72, 73 (also see FIG. 15 and also below). The conditioning learnable layer(s) 71, 72, 73 may generate conditions (some of which may be indicated as β, beta, and γ, gamma, or the numbers 74 and 75), which are also called conditioning feature parameters to be applied to the first data 12, and any upsampled data derived from the first data. The conditioning learnable layer(s) 71, 72, 73 may be in the form of matrixes with multiple channels and multiple samples for each frame. The first processing block 40 may include a denormalization (or styling element) block 77. For example, the styling element 77 may apply the conditioning feature parameters 74 and 75 to the first data 15. An example may be element wise multiplication of the values of the first data by the condition β (which may operate as bias) and an addition with the condition γ (which may operate as multiplier). The styling element 77 may produce a first output data 69 sample by sample.

The decoder 10 (10d) may include a second processing block 45. The second processing block 45 may combine the plurality of channels of the first output data 69, to obtain the output audio signal 16 (or its precursor the audio signal 44′, as shown in FIG. 14).

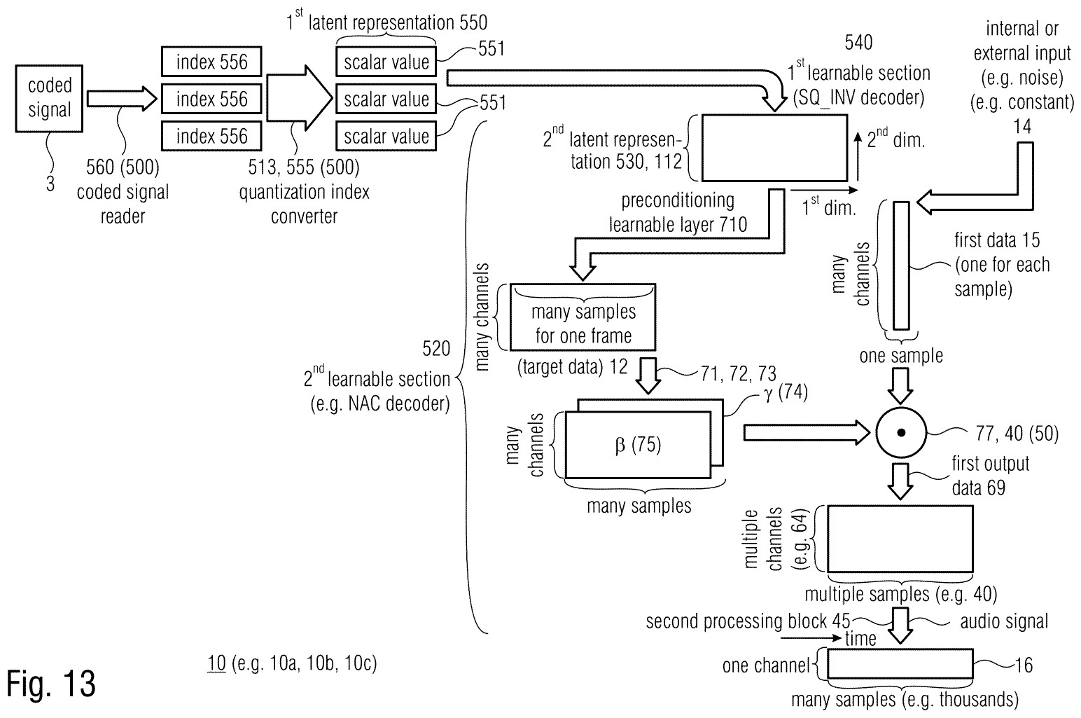

Reference is now mainly made to FIG. 13. The coded signal 3 is subdivided onto a plurality of frames, which are however encoded in the form of indexes 356, 556 (e.g. as obtained from the quantization module 300 of the encoder 2). From the indexes 356, 556 of the coded signal 3, a first latent representation 550 is obtained through the quantization module 500 (513), to obtain the scalar values 551, to be grouped in codes. First and second dimensions are shown in codes 112 (530) of FIG. 13 (other dimensions may be present). Each frame is subdivided into a plurality of samples in the abscissa direction (first, inter frame dimension). The first latent representation 550 may be used by the preconditioning learnable layer(s) 710 (e.g. recurrent learnable layer(s)) to generate target data 12, which may also be in at least two dimensions (e.g. multi-dimensional), such as in the form of a spectrogram (e.g., a mel-spectrogram, but this is not strictly necessary). Each target data 12 may represent one single frame and the sequence of frames may evolve, in the abscissa direction (from left to right) with time, along the first, inter frame dimension. Several channels may be in the ordinate direction (second, intra frame dimension) for each frame. For example, different coefficients will take place in different entries of each column in association with coefficients associated with the frequency bands. Conditioning learnable layer(s) 71, 72, 73, generate feature parameter(s) 74, 75 (β and γ). The abscissa (second, intra frame dimension) of β and γ is associated to different samples of the same frame, while the ordinate (first, inter frame dimension) is associated to different channels. In parallel, the first data provisioner 702 may provide the first data 15. A first data 15 may be generated for each sample and may have many channels. At the styling element 77 (and more in general, at the first conditioning block 40) the conditioning feature parameters β and γ (74, 75) may be applied to the first data 15. For example, an element-by-element multiplication may be performed between a column of the styling conditions 74, 75 (conditioning feature parameters) and the first data 15 or an evolution thereof. It will be shown that this process may be reiterated many times.

As clear from above, the first output data 69 generated by the first processing block 40 may be obtained as a 2-dimensional matrix with samples in abscissa (first, inter frame dimension) and channels in ordinate (second, intra frame dimension). Through the second processing block 45, the audio signal 16 may be generated having one single channel and multiple samples (e.g., in a shape similar to the input audio signal 1), in particular in the time domain. More in general, at the second processing block 45, the number of samples per frame (bitrate, also called sampling rate) of the first output data 69 may evolve from a second number of samples per frame (second bitrate or second sampling rate) to a third number of samples per frame (third bitrate or third sampling rate), higher than the second number of samples per frame (second bitrate or second sampling rate). On the other side, the number of channels of the first output data 69 may evolve from a second number of channels to a third number of channels, which is less than the second number of channels. Said in other terms, the bitrate or sampling rate (third bitrate or third sampling rate) of the output audio signal 16 may be higher than the bitrate (or sampling rate) of the first data 15 (first bitrate or first sampling rate) and of the bitrate or sampling rate (second bitrate or second sampling rate) of the first output data 69, while the number of channels of the output audio signal 16 may be lower than the number of channels of the first data 15 (first number of channels) and of the number of channels (second number of channels) of the first output data 69.

Examples of convolutions are discussed here below and it can be understood that they may be used at any of the preconditional learnable layer(s) 710 (e.g. recurrent learnable layer(s)), at least one conditional learnable layers 71, 72, 73, and more in general, in the first processing block 40 (50). In general terms, the arriving set of conditional parameters (e.g., for one frame) may be stored in a queue (not shown) to be subsequently processed by the first or second processing block while the first or second processing block, respectively, processes a previous frame.

A discussion on the operations mainly performed in blocks downstream to the preconditioning learnable layer(s) 710 (e.g. recurrent learnable layer(s)) is now provided. We take into account the target data 12 already obtained from the preconditioning learnable layer(s) 710, and which are applied to the conditioning learnable layer(s) 71-73 (the conditioning learnable layer(s) 71-73 being, in turn, applied to the stylistic element 77). Blocks 71-73 and 77 may be embodied by a generator network layer 770. The generator network layer 770 may include a plurality of learnable layers (e.g. a plurality of blocks 50a-50h, see below).

FIG. 12 (and its embodiment in FIG. 14) shows an example of the audio decoder (generator) 10 (10d), e.g. 10b, 10c, which can decode (e.g. generate, synthesize) the audio signal (output signal) 16 from the coded signal 3, e.g. according to the present techniques (also called StyleMelGAN). The output audio signal 16 may be generated based on the input signal 14 (which may be noise, e.g. white noise (“first option”), or which can be obtained from another source. The target data 12 may, as explained above, comprise (e.g. be) a spectrogram (e.g., a mel-spectrogram), the spectrogram (e.g. mel-spectrogram) providing mapping, for example, of a sequence of time samples onto mel scale (e.g. obtained from the preconditioning learnable layer(s) 710). The target data 12 and/or the first data 15 is/are in general to be processed, in order to obtain a speech sound recognizable as natural by a human listener. In the decoder 10d, the first data 15 obtained from the input is styled (e.g. at block 77) to have a vector with the acoustic features conditioned by the target data 12. At the end, the output audio signal 16 will be recognized as speech by a human listener. The input vector 14 and/or the first data 15 (e.g. noise e.g. obtained from an internal or external source) may be, like in FIG. 14, a 128×1 vector (one single sample, e.g. time domain samples or frequency domain samples, and 128 channels) (FIG. 14 shows the input signal 14, to be provided to the channel mapping 30, the first data provisioner 702 not being shown or being considered to be the same as the channel mapping 30). A different length of the input vector 14 could be used in other examples. The input vector 14 may be processed (e.g. under the conditioning of the target data 12 obtained from the coded signal 3 through the preconditioning layer(s) 710) in the first processing block 40. The first processing block 40 may include at least one, e.g. a plurality of, processing blocks 50 (e.g. 50a. . . 50h). In FIG. 14 there are shown eight blocks 50a. . . 50h (each of them is also identified as “TADEResBlock”), even though a different number may be chosen in other examples. In many examples, the processing blocks 50a, 50b, etc. provide a gradual upsampling of the signal which evolves from the input signal 14 to the final audio signal 16 (e.g., at least some processing blocks, e.g. 50a, 50b, 50c, 50d, 50e increases the sampling rate, in such a way that each of them increases the sampling rate (also called bitrate) in output with respect to the sampling rate in its input), while some other processing blocks (e.g. 50f-50h) (e.g. downstream with respect to those (e.g. 50a, 50b, 50c, 50d, 50e) which increase the sampling rate) do not increase the sampling rate (or bitrate). The blocks 50a-50h may be understood as forming one single block 40 (e.g. the one shown in FIG. 12). In the first processing block 40, a conditioning set of learnable layers (e.g., 71, 72, 73, but different numbers are possible) may be used to process the target data 12 and the input signal 14 (e.g., first data 15). Accordingly, conditioning feature parameters 74, 75 (also referred to as gamma, γ, and beta, β) may be obtained, e.g. by convolution, during training. The learnable layer(s) 71-73 may therefore be part of a weight layer of a learning network. As explained above, the first processing block(s) 40, 50 may include at least one styling element 77 (normalization block 77). The at least one styling element 77 may output the first output data 69 (when there are a plurality of processing blocks 50, a plurality of styling elements 77 may generate a plurality of components, which may be added to each other to obtain the final version of the first output data 69). The at least one styling element 77 may apply the conditioning feature parameters 74, 75 to the input signal 14 (latent) or the first data 15 obtained from the input signal 14.

The first output data 69 may have a plurality of channels. The generated audio signal 16 may have one single channel.

The decoder 10 (10d) may include a second processing block 45 (in FIG. 14 shown as including the blocks 42, 44, 46). The second processing block 45 may be configured to combine the plurality of channels (indicated with 47 in FIG. 14) of the first output data 69 (inputted as second input data or second data), to obtain the output audio signal 16 in one single channel, but in a sequence of samples (in FIG. 14, the samples are indicated with 49).

The “channels” are not to be understood in the context of stereo sound, but in the context of neural networks (e.g. convolutional neural networks) or more in general of the learnable units. For example, the input signal (e.g. latent noise) 14 may be in 128 channels (in the representation in the time domain), since a sequence of channels are provided. For example, when the signal has 40 samples and 64 channels, it may be understood as a matrix of 40 columns and 64 rows, while when the signal has 20 samples and 64 channels, it may be understood as a matrix of 20 columns and 64 rows (other schematizations are possible). Therefore, the generated audio signal 16 may be understood as a mono signal. In case stereo signals are to be generated, then the disclosed technique is simply to be repeated for each stereo channel, so as to obtain multiple audio signals 16 which are subsequently mixed.

At least the original input audio signal 1 and/or the generated speech 16 may be a sequence of time domain values. To the contrary, the output of each (or at least one of) the blocks 30 and 50a-50h, 42, 44 may have in general a different dimensionality. In at least some of the blocks 30 and 50a-50e, 42, 44, the signal (14, 15, 59, 69), evolving from the input 14 (e.g. noise or LPC parameters, or other parameters, taken from the coded signal) towards becoming speech 16, may be upsampled. For example, at the first block 50a among the blocks 50a-50h, a 2-times upsampling may be performed. An example of upsampling may include, for example, the following sequence: 1) repetition of same value, 2) insert zeros, 3) another repeat or insert zero+linear filtering, etc.

The generated audio signal 16 may generally be a single-channel signal. In case multiple audio channels are necessary (e.g., for a stereo sound playback) then the claimed procedure may be in principle iterated multiple times.

Analogously, also the target data 12 may have multiple channels (e.g. in spectrogram, such as mel-spectrogram), as generated by the preconditioning learnable layer(s) 710. In some examples, the target data 12 may be upsampled (e.g. by a factor of two, a power of 2, a multiple of 2, or a value greater than 2, e.g. by a different factor, such as 2.5 or a multiple thereof) to adapt to the dimensions of the signal (59a, 15, 69) evolving along the subsequent layers (50a-50h, 42), e.g. to obtain the conditioning feature parameters 74, 75 in dimensions adapted to the dimensions of the signal.

If the first processing block 40 is instantiated in multiple blocks (e.g. 50a-50h), the number of channels may, for example, remain at least some of the multiple blocks (e.g., from 50e to 50h and in block 42 the number of channels does not change). The first data 15 may have a first dimension or at least one dimension lower than that of the audio signal 16. The first data 15 may have a total number of samples across all dimensions lower than the audio signal 16. The first data 15 may have one dimension lower than the audio signal 16 but a number of channels greater than the audio signal 16.

As explained by the wording “conditioning set of learnable layers”, the audio decoder 10 (10d) may be obtained according to the paradigms of conditional neural networks, e.g. based on conditional information. For example, conditional information may be constituted by target data (or upsampled version thereof) 12 from which the conditioning set of layer(s) 71-73 (weight layer) are trained and the conditioning feature parameters 74, 75 are obtained. Therefore, the styling element 77 is conditioned by the learnable layer(s) 71-73. The same may apply to the preconditional layers 710.

Examples at the encoder 2 (or at the first encoded-side learnable layer 20) and/or at the decoder 10 (10d) may be based on convolutional neural networks. For example, a little matrix (e.g., filter or kernel), which could be a 3×3 matrix (or a 4×4 matrix, or 1×1, or less than 10×10 etc.), is convolved (convoluted) along a bigger matrix (e.g., the channel x samples latent or input signal and/or the spectrogram and/or the spectrogram or upsampled spectrogram or more in general the target data 12), e.g. implying a combination (e.g., multiplication and sum of the products; dot product, etc.) between the elements of the filter (kernel) and the elements of the bigger matrix (activation map, or activation signal). During training, the elements of the filter (kernel) are obtained (e.g. learnt) which are those that minimize the losses. During inference, the elements of the filter (kernel) are used which have been obtained during training. Examples of convolutions may be used at at least one of blocks 71-73, 61b, 62b (see below), 230, 250, 290, 429, 440, 460. Notably, instead of matrixes may be used. Where a convolution is conditional, then the convolution is not necessarily applied to the signal evolving from the input signal 14 towards the audio signal 16 through the intermediate signals 59a (15), 69, etc., but may be applied to the target signal 14 (e.g. for generating the conditioning feature parameters 74 and 75 to be subsequently applied to the first data 15, or latent, or prior, or the signal evolving form the input signal towards the speech 16). In other cases (e.g. at blocks 61b, 62b, see below) the convolution may be non-conditional, and may for example be directly applied to the signal 59a (15), 69, etc., evolving from the input signal 14 towards the audio signal 16. Both conditional and non-conditional convolutions may be performed.

It is possible to have, in some examples (at the decoder or at the encoder), activation functions downstream to the convolution (ReLu, TanH, softmax, etc.), which may be different in accordance to the intended effect. ReLu may map the maximum between 0 and the value obtained at the convolution (in practice, it maintains the same value if it is positive, and outputs 0 in case of negative value). Leaky ReLu may output x if x>0, and 0.1*x if x≤0, x being the value obtained by convolution (instead of 0.1 another value, such as a predetermined value within 0.1±0.05, may be used in some examples). TanH (which may be implemented, for example, at block 63a and/or 63b) may provide the hyperbolic tangent of the value obtained at the convolution, e.g. TanH(x)=(e^{x}−e^{-x})/(e^{x}+e^{-x}), with x being the value obtained at the convolution (e.g. at block 61b, see below). Softmax (e.g. applied, for example, at block 64b) may apply the exponential to each element of the elements of the result of the convolution, and normalize it by dividing by the sum of the exponentials. Softmax may provide a probability distribution for the entries which are in the matrix which results from the convolution (e.g. as provided at 62b). After the application of the activation function, a pooling step may be performed (not shown in the figures) in some examples, but in other examples it may be avoided. It is also possible to have a softmax-gated TanH function, e.g. by multiplying (e.g. at 65b, see below) the result of the TanH function (e.g. obtained at 63b, see below) with the result of the softmax function (e.g. obtained at 64b). Multiple layers of convolutions (e.g. a conditioning set of learnable layers, or at least one conditioning learnable layer) may, in some examples, be one downstream to another one and/or in parallel to each other, so as to increase the efficiency. If the application of the activation function and/or the pooling are provided, they may also be repeated in different layers (or maybe different activation functions may be applied to different layers, for example) (this may also apply to the encoder).

At the decoder 10 (10d), the input signal 14 is processed, at different steps, to become the generated audio signal 16 (e.g. under the conditions set by the conditioning set(s) of learnable layer(s) or the learnable layer(s) 71-73, and on the parameters 74, 75 learnt by the conditioning set(s) of learnable layer(s) or the learnable layer(s) 71-73). Therefore, the input signal 14 (or its evolved version, i.e. the first data 15) can be understood as evolving in a direction of processing (from 14 to 16 in FIGS. 4 and 7) towards becoming the generated audio signal 16 (e.g. speech). The conditions will be substantially generated based on the target signal 12 and/or on the preconditions in the coded signal 3, and on the training (so as to arrive at the most preferable set of parameters 74, 75).

It is also noted that the multiple channels of the input signal 14 (or any of its evolutions) may be considered to have a set of learnable layers and a styling element 77 associated thereto. For example, each row of the matrixes 74 and 75 may be associated to a particular channel of the input signal (or one of its evolutions), e.g. obtained from a particular learnable layer associated to the particular channel. Analogously, the styling element 77 may be considered to be formed by a multiplicity of styling elements (each for each row of the input signal x, c, 12, 76, 76′, 59, 59a, 59b, etc.).

FIG. 14 shows an example of the audio decoder 10 (10d). FIG. 14 does now show the preconditioning learnable layer 710 (shown in FIG. 12), even though the target data 12 are obtained from the coded signal 3 through the preconditioning layer(s) 710 (see above). The target data 12 may be a mel-spectrogram obtain from the preconditioning learnable layer 710; the input signal 14 may be a signal obtained from internal or external source, and the output 16 may be speech. The input signal 14 may have only one sample and multiple channels (indicated as “x”, because they can vary, for example the number of channels can be 80 or something else). The input vector 14 may be obtained in a vector with 128 channels (but other numbers are possible). In case the input signal 14 is noise (“first option”), it may have a zero-mean normal distribution, and follow the formula z˜N(0, I₁₂₈); it may be a random noise of dimension 128 with mean 0, and with an autocorrelation matrix (square 128×128) equal to the identity I (different choice may be made). Hence, in examples in which the noise is used as input signal 14, it can be completely decorrelated between the channels and of variance 1 (energy). N(0, I₁₂₈) may be realized at every 22528 generated samples (or other numbers may be chosen for different examples); the dimension may therefore be 1 in the time axis and 128 in the channel axis. In examples, the input signal 14 may be a constant value.

The input vector 14 may be step-by-step processed (e.g., at blocks 702, 50a-50h, 42, 44, 46, etc.), so as to evolve to speech 16 (the evolving signal will be indicated, for example, with different signals 15, 59a, x, c, 76′, 79, 79a, 59b, 79b, 69, etc.).

At block 30, a channel mapping may be performed. It may consist of or comprise a simple convolution layer to change the number channels, for example in this case from 128 to 64. Block 30 may therefore be learnable (in some examples, it may be deterministic). As can be seen, at least some of the processing blocks 50a, 50b, 50c, 50d, 50e, 50f, 50g, 50h (altogether embodying the first processing block 50 of FIG. 6) may increase the number of samples by performing an upsampling (e.g., maximum 2-upsampling), e.g. for each frame. The number of channels may remain the same (e.g., 64) along blocks 50a, 50b, 50c, 50d, 50e, 50f, 50g, 50h. The samples may be, for example, the number of samples per second (or other time unit): we may obtain, at the output of block 50h, sound at 16 kHz or more (e.g. 22 Khz). As explained above, a sequence of multiple samples may constitute one frame. Each of the blocks 50a-50h (50) can also be a TADEResBlock (residual block in the context of TADE, Temporal Adaptive DEnormalization). Notably, each block 50a-50h (50) may be conditioned by the target data (e.g., codes) 12 and/or by the coded signal 3 At a second processing block 45 (FIGS. 1 and 6), only one single channel may be obtained, and multiple samples are obtained in one single dimension (see also FIG. 13). As can be seen, another TADEResBlock 42 (further to blocks 50a-50h) may be used (which reduces the dimensions to four single channels). Then, a convolution layer 44 and an activation function (which may be TanH 46, for example) may be performed. A (Pseudo Quadrature Mirror Filter)-bank) 110 may also be applied, so as to obtain the final 16 (and, possibly, stored, rendered, etc.).

At least one of the blocks 50a-50h (or each of them, in particular examples) and 42, as well as the encoder layers 230, 240 and 250 (and 430, 440, 450, 460), may be, for example, a residual block. A residual learnable block (layer) may operate a prediction to a residual component of the signal evolving from the input signal 14 (e.g. noise) to the output audio signal 16. The residual signal is only a part (residual component) of the main signal evolving form the input signal 14 towards the output signal 16. For example, multiple residual signals may be added to each other, to obtain the final output audio signal 16. Other architectures may be notwithstanding used.

FIG. 15 shows an example of one of the blocks 50a-50h (50). The blocks 50a-50h (50) may be replica with each other, although, when trained, they may result to As can be seen, each block 50 (50a-50h) is inputted with a first data 59a, which is either the first data 15, (or the upsampled version thereof, such as that output by the upsampling block 30) or the output from a preceding block. For example, the block 50b may be inputted with the output of block 50a; the block 50c may be inputted with the output of block 50b, and so on. In examples, different blocks may operate in parallel to each other, and there results are added together. From FIG. 15 it is possible to see that the first data 59a provided to the block 50 (50a-50h) or 42 is processed and its output is the output data 69 (which will be provided as input to the subsequent block). As indicated by the line 59a′, a main component of the first data 59a actually bypasses most of the processing of the first processing block 50a-50h (50). For example, blocks 60a, 900, 60b and 902 and 65b are bypassed by the main component 59a′. The residual component 59a of the first data 59 (15) may be processed to obtain a residual portion 65b′ to be added to the main component 59a′ at an adder 65c (which is indicated in FIG. 15, but not shown). The bypassing main component 59a′ and the addition at the adder 65c may be understood as instantiating the fact that each block 50 (50a-50h) processes operations to residual signals, which are then added to the main portion of the signal. Therefore, each of the blocks 50a-50h can be considered a residual block. The addition at adder 65c does not necessarily need to be performed within the residual block 50 (50a-50h). A single addition of a plurality of residual signals 65b′ (each outputted by each of residual blocks 50a-50h) can be performed (e.g., at one single adder block in the second processing block 45, for example). Accordingly, the different residual blocks 50a-50h may operate in parallel with each other. In the example of FIG. 15, each block 50 (50a-50h) may repeat its convolution layers twice. A first denormalization block 60a and a second denormalization block 60b may be used in cascade. The first denormalization block 60a may include an instance of the stylistic element 77, to apply the conditioning feature parameters 74 and 75 to the first data 59 (15) (or its residual version 59a). The first denormalization block 60a may include a normalization block 76. The normalization block 76 may perform a normalization along the channels of the first data 59 (15) (e.g. its residual version 59a). The normalized version c (76′) of the first data 59 (15) (or its residual version 59a) may therefore be obtained. The stylistic element 77 may therefore be applied to the normalized version c (76′), to obtain a denormalized (conditioned) version of the first data 59 (15) (or its residual version 59a). The denormalization at element 77 may be obtained, for example, through an element-by-element multiplication of the elements of the matrix γ (which embodies the condition 74) and the signal 76′ (or another version of the signal between the input signal and the speech), and/or through an element-by-element addition of the elements of the matrix β (which embodies the condition 75) and the signal 76′ (or another version of the signal between the input signal and the speech). A denormalized version 59b (conditioned by the conditioning feature parameters 74 and 75) of the first data 59 (15) (or its residual version 59a) may therefore be obtained.

Then, a gated activation 900 may be performed on the denormalized version 59b of the first data 59 (e.g. its residual version 59a). In particular, two convolutions 61b and 62b may be performed (e.g., each with 3×3 kernel and with dilation factor 1). Different activation functions 63b and 64b may be applied respectively to the results of the convolutions 61b and 62b. The activation 63b may be TanH. The activation 64b may be softmax. The outputs of the two activations 63b and 64b may be multiplied by each other, to obtain a gated version 59c of the denormalized version 59b of the first data 59 (or its residual version 59a). Subsequently, a second denormalization 60b may be performed on the gated version 59c of the denormalized version 59b of the first data 59 (or its residual version 59a). The second denormalization 60b may be like the first denormalization and is therefore here not described. Subsequently, a second activation 902 may performed. Here, the kernel may be 3×3, but the dilation factor may be 2. In any case, the dilation factor of the second gated activation 902 may be greater than the dilation factor of the first gated activation 900. The conditioning set of learnable layer(s) 71-73 (e.g. as obtained from the preconditioning learnable layer(s)) and the styling element 77 may be applied (e.g. twice for each block 50a, 50b . . . ) to the signal 59a. An upsampling of the target data 12 may be performed at upsampling block 70, to obtain an upsampled version 12′ of the target data 12. The upsampling may be obtained through non-linear interpolation, and may use e.g. a factor of 2, a power of 2, a multiple of two, or another value greater than 2. Accordingly, in some examples it is possible to have that the spectrogram (e.g. mel-spectrogram) 12′ has the same dimensions (e.g. conform to) the signal (76, 76′, c, 59, 59a, 59b, etc.) to be conditioned by the spectrogram. In examples, the first and second convolutions at 61b and 62b, respectively downstream to the TADE block 60a or 60b, may be performed at the same number of elements in the kernel (e.g., 9, e.g., 3×3). However, the second convolutions in block 902 may have a dilation factor of 2. In examples, the maximum dilation factor for the convolutions may be 2 (two).

As explained above, the target data 12 may be upsampled, e.g. so as to conform to the input signal (or a signal evolving therefrom, such as 59, 59a, 76′, also called latent signal or activation signal). Here, convolutions 71, 72, 73 may be performed (an intermediate value of the target data 12 is indicated with 71′), to obtain the parameters γ (gamma, 74) and β (beta, 75). The convolution at any of 71, 72, 73 may also require a rectified linear unit, ReLu, or a leaky rectified linear unit, leaky ReLu. The parameters γ and β may have the same dimension of the activation signal (the signal being processed to evolve from the input signal 14 to the generated audio signal 16, which is here represented as x, 59, 59a, or 76′ when in normalized form). Therefore, when the activation signal (x, 59, 59a, 76′) has two dimensions, also γ and β (74 and 75) have two dimensions, and each of them is superimposable to the activation signal (the length and the width of γ and β may be the same of the length and the width of the activation signal). At the stylistic element 77, the conditioning feature parameters 74 and 75 are applied to the activation signal (which may be the first data 59a or the 59b output by the multiplier 65a). It is to be noted, however, that the activation signal 76′ may be a normalized version (at instance norm block 76) of the first data 59, 59a, 59b (15), the normalization being in the channel dimension. It is also to be noted that the formula shown in stylistic element 77 (γ*c+β, also indicated with γ⊙+β in FIG. 15) may be an element-by-element product, and in some examples is not a convolutional product or a dot product. The convolutions 72 and 73 have not necessarily activation function downstream of them. The parameter γ (74) may be understood as having variance values and β (75) as having bias values. It is noted that for each block 50a-50h, 42, the learnable layer(s) 71-73 (e.g. together with the styling element 77) may be understood as embodying weight layers. Also, block 42 of FIG. 14 may be instantiated as block 50 of FIG. 15. Then, for example, a convolutional layer 44 will reduce the number of channels to 1 and, after that, a TanH 46 is performed to obtain speech 16. The output 44′ of the blocks 44 and 46 may have a reduced number of channels (e.g. 4 channels instead of 64), and/or may have the same number of channels (e.g., 40) of the previous block 50 or 42.

A pseudo quadrature mirror filter, PQMF, synthesis (see also below) 110 may be performed on the signal 44′, so as to obtain the audio signal 16 e.g. in one channel (other techniques may be used).

In examples, the coded signal 3 may be transmitted (e.g., through a communication medium, e.g. a wired connection and/or a wireless connection), and/or may be stored (e.g., in a storage unit). The encoder 3 and/or the first encoded-side learnable layer 20 may therefore comprise and/or be connected and/or be configured to control transmissions units (e.g., modems, transceivers, etc.) and/or storage units (e.g. mass memories, etc.). In order to permit storage and/or transmission, between the quantization module 300 and the dequantization module 500 (513) there may be other devices that process the coded signal for the purpose of storing and/or transmitting, and reading and/or receiving.

### Prejudice Against Scalar Quantization in the Context of Traditional Neural Audio Coding:

Reference [10], a seminal paper for discrete representation learning, claims that VQ achieves stronger compression than SQ, which is not the case.
VQ-VAE [12]: claims that soft-to-hard technique is not realizable
Minje Kim paper [13]: also uses soft-to-hard but with scalar quantization, however, in our experiments soft-to-hard training never worked well.
   The training technique requires trainable codebooks, which is not mandatory for our scalar quantization technique.
   Target bitrates are much higher than what we are targeting: 12, 20, 32 kbps.
Traditional competitor Soundstream [14]: The authors claim that VQ is the commonly used technique for neural audio codecs, which is also our perception.
Similarly, a recent journal paper explicitly considering quantization techniques for neural audio coding [15] does only mention VQ-related approaches and neglects SQ in the review. Hence, this paper implicitly claims that VQ is more suitable for neural audio coding.
Scalar quantization has been successfully used for neural image coding (e.g., [16]) using high bitrates, but has not been successfully used for neural audio coding at low bit rates (below 4 kbps).
competitor Encodec [17]: Compared VQ to a simple SQ version and claimed that VQ is superior to SQ in preliminary experiments. The authors did not follow up on SQ and do even not provide results for it.

### Further Examples

Generally, examples may be implemented as a computer program product with program instructions, the program instructions being operative for performing one of the methods when the computer program product runs on a computer. The program instructions may for example be stored on a machine readable medium. Other examples comprise the computer program for performing one of the methods described herein, stored on a machine readable carrier. In other words, an example of method is, therefore, a computer program having a program instructions for performing one of the methods described herein, when the computer program runs on a computer. A further example of the methods is, therefore, a data carrier medium (or a digital storage medium, or a computer-readable medium) comprising, recorded thereon, the computer program for performing one of the methods described herein. The data carrier medium, the digital storage medium or the recorded medium are tangible and/or non-transitionary, rather than signals which are intangible and transitory. A further example of the method is, therefore, a data stream or a sequence of signals representing the computer program for performing one of the methods described herein. The data stream or the sequence of signals may for example be transferred via a data communication connection, for example via the Internet. A further example comprises a processing means, for example a computer, or a programmable logic device performing one of the methods described herein. A further example comprises a computer having installed thereon the computer program for performing one of the methods described herein. A further example comprises an apparatus or a system transferring (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver. In some examples, a programmable logic device (for example, a field programmable gate array) may be used to perform some or all of the functionalities of the methods described herein. In some examples, a field programmable gate array may cooperate with a microprocessor in order to perform one of the methods described herein. Generally, the methods may be performed by any appropriate hardware apparatus. The above described examples are merely illustrative for the principles discussed above. It is understood that modifications and variations of the arrangements and the details described herein will be apparent. It is the intent, therefore, to be limited by the scope of the claims and not by the specific details presented by way of description and explanation of the examples herein. Equal or equivalent elements or elements with equal or equivalent functionality are denoted in the following description by equal or equivalent reference numerals even if occurring in different figures.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### References

[1] Zeghidour, Neil, Alejandro Luebs, Ahmed Omran, Jan Skoglund, und Marco Tagliasacchi. “SoundStream: An End-to-End Neural Audio Codec”. arXiv, 7 Jul. 2021. http://arxiv.org/abs/2107.03312.
[2] Défossez, Alexandre, Jade Copet, Gabriel Synnaeve, und Yossi Adi. “High Fidelity Neural Audio Compression”. arXiv, 24 Oct. 2022. http://arxiv.org/abs/2210.13438.
[3] Zhen, Kai, Jongmo Sung, Mi Suk Lee, Seungkwon Beack, und Minje Kim. “Scalable and Efficient Neural Speech Coding: A Hybrid Design”. IEEE/ACM Transactions on Audio, Speech, and Language Processing 30 (2022): 12-25.
[4] Jiang, Xue, Xiulian Peng, Huaying Xue, Yuan Zhang, und Yan Lu. “Cross-Scale Vector Quantization for Scalable Neural Speech Coding”. arXiv, 6 Jul. 2022. http://arxiv.org/abs/2207.03067.
[5] Pia, Nicola, Kishan Gupta, Srikanth Korse, Markus Multrus, und Guillaume Fuchs. “NESC: Robust Neural End-2-End Speech Coding with GANs”. arXiv, 7 Jul. 2022. http://arxiv.org/abs/2207.03282.
[6] Oord, Aaron van den, Oriol Vinyals, und Koray Kavukcuoglu. “Neural Discrete Representation Learning”. arXiv, 30 May 2018. http://arxiv.org/abs/1711.00937.
[7] Agustsson, Eirikur, Fabian Mentzer, Michael Tschannen, Lukas Cavigelli, Radu Timofte, Luca Benini, und Luc Van Gool. “Soft-to-Hard Vector Quantization for End-to-End Learning Compressible Representations”. arXiv, 8 Jun. 2017. http://arxiv.org/abs/1704.00648.
[8] Jang, Eric, Shixiang Gu, und Ben Poole. “Categorical Reparameterization with Gumbel-Softmax”. arXiv, 5 Aug. 2017. http://arxiv.org/abs/1611.01144.
[9] Balle, Johannes, Philip A. Chou, David Minnen, Saurabh Singh, Nick Johnston, Eirikur Agustsson, Sung Jin Hwang, und George Toderici. “Nonlinear Transform Coding”. IEEE Journal of Selected Topics in Signal Processing 15, Nr. 2 (February 2021): 339-53.
[10] Agustsson, Eirikur, Fabian Mentzer, Michael Tschannen, Lukas Cavigelli, Radu Timofte, Luca Benini, und Luc Van Gool. “Soft-to-Hard Vector Quantization for End-to-End Learning Compressible Representations”. arXiv, 8 Jun. 2017. http://arxiv.org/abs/1704.00648.
[12] Oord, Aaron van den, Oriol Vinyals, und Koray Kavukcuoglu. “Neural Discrete Representation Learning”. arXiv, 30 May 2018. http://arxiv.org/abs/1711.00937.
[13] Zhen, Kai, Jongmo Sung, Mi Suk Lee, Seungkwon Beack, und Minje Kim. “Scalable and Efficient Neural Speech Coding: A Hybrid Design”. IEEE/ACM Transactions on Audio, Speech, and Language Processing 30 (2022): 12-25. https: //doi.org/10.1109/TASLP.2021.3129353.
[14] Zeghidour, Neil, Alejandro Luebs, Ahmed Omran, Jan Skoglund, und Marco Tagliasacchi. “SoundStream: An End-to-End Neural Audio Codec”. arXiv, 7 Jul. 2021. http://arxiv.org/abs/2107.03312.
[15] M. H. Vali and T. Bäckström, “NSVQ: Noise Substitution in Vector Quantization for Machine Learning,” in IEEE Access, vol. 10, pp. 13598-13610, 2022, doi: 10.1109/ACCESS.2022.3147670.
[16] J. Ballé, V. Laparra, and E. P. Simoncelli, “End-to-end optimized image compression, ” in Proc. 5th Int. Conf. Learn. Represent., 2017, pp. 1-27
[17] Défossez, Alexandre, Jade Copet, Gabriel Synnaeve, und Yossi Adi. “High Fidelity Neural Audio Compression”. arXiv, 24 Oct. 2022. http://arxiv.org/abs/2210.13438.

1. A decoder, configured to generate an audio signal from a coded signal representing the audio signal, the decoder comprising:
a coded signal reader, configured to read the coded signal, thereby providing a plurality of indexes;
a scalar dequantization module, comprising:
a plurality of quantization index converters, each quantization index converter being configured to convert an index of the plurality of indexes onto a corresponding latent scalar value, so that a plurality of latent scalar values form a first latent audio signal representation of the audio signal; and
a first learnable section to provide a second latent representation from the first latent audio signal representation; and
a second learnable section comprising at least one learnable layer and configured to generate the audio signal from the second latent audio signal representation.

2. The decoder of claim 1, wherein each quantization index converter is configured to provide one single latent scalar value using at least one codebook which is different from the codebooks used by any other quantization index converter.

3. The decoder of claim 1, wherein all, or at least a multiplicity which is a subset of, the quantization index converters are configured to provide a respective plurality of the scalar values using at least one codebook which is a common codebook.

4. The decoder of claim 2, wherein at least one quantization index converter is a residual or multi-stage quantization index converter.

5. The decoder of claim 2, wherein at least one codebook is learnable.

6. The decoder of claim 1, wherein the second learnable section comprises a styling or normalizing learnable element conditioning of the second latent representation or a processed version thereof.

7. The decoder of claim 2, wherein at least one codebook has a variable-length representation in the bitstream.

8. The decoder of claim 7, configured so that, at least for two of the latent scalar values, or for all the latent scalar values, more frequent latent scalar values are converted from indexes with a representation that is more compact in the coded signal than indexes mapped onto less frequent scalar values.

9. The decoder of claim 2, wherein at least one codebook or quantization is non-uniform, where the value range to quantize is divided into unequal intervals, in such a way that more frequent intervals are smaller than less frequent intervals.

10. The decoder of claim 1, configured to select between at least one first decoding mode and one second decoding mode, wherein the first decoding mode is a first, low-quantization-index-converter-number, decoding mode and the second decoding mode is a second, high-quantization-index-converter-number, decoding mode, wherein the decoder is configured, in the first decoding mode, to provide, to the first learnable section, less latent scalar values in the first decoding mode than in the second decoding mode, the decoder thereby using less quantization index converters in the first decoding mode than in the second decoding mode.

11. The decoder of claim 10, configured to select between at least one first decoding mode and one second decoding mode, wherein the first decoding mode is a first, low-index number, decoding mode and the second decoding mode is a second, high-index number, decoding mode, and configured, in the second, high-index number, decoding mode, to use at least one codebook with a higher number of indexes, with higher resolution, and/or with higher bitlength than in the first, low-index number, decoding mode.

12. The decoder of claim 1, configured to select between at least one first decoding mode and one second decoding mode, so that:
in the second decoding mode, there are used the plurality of quantization index converters to provide the plurality of scalar values, each quantization index converter being configured to provide one single scalar value, or a component thereof from one respective index of the plurality of indexes; and
in the first decoding mode, there is used one vectorial quantization index converter to provide multiple scalar values from one single index of the plurality of indexes.

13. The decoder of claim 1, configured to select between at least one first decoding mode and one second decoding mode, wherein the second decoding mode is multi-stage, with a second number of stages, and the first decoding mode is either single-stage or multistage with a first number of stages smaller than the second number of stages, so that:
in the first decoding mode, there are used the plurality of quantization index converters to provide the plurality of indexes, each quantization index converter being configured to convert one single index onto one single scalar value, or a plurality of indexes in the first number onto one scalar value; and
in second decoding mode, there is used at least one quantization index converter to convert indexes, in the second number, to provide at least one scalar value.

14. The decoder of claim 1, configured to select between at least one first classification decoding mode and one second classification decoding mode based on a classification of the input audio signal, wherein the first classification decoding mode is trained for a first class of the classification and the second decoding mode is trained for a second class of the classification.

15. The decoder of claim 10, configured to select between the at least one first and second decoding mode based on a signalization written in the coded signal.

16. The decoder of claim 1, wherein the second learnable section is configured to change the dimension of the latent representation from the first latent representation to the second latent representation.

17. The decoder of claim 1, comprising:
a first data provisioner configured to provide first data derived from an input signal;
a first processing block, configured to receive the first data and to output first output data in the given frame,
the decoder further comprising:
at least one conditioning learnable layer configured to process target data, from the second latent representation, to output conditioning feature parameters; and
a styling element, configured to apply the conditioning feature parameters to the first data or normalized first data.

18. The decoder of claim 17, configured to acquire the input signal from noise.

19. The decoder of claim 16, further comprising at least one preconditioning learnable layer configured to receive the second latent representation and output target data representing the audio signal.

20. The decoder of claim 16, wherein a first convolution layer is configured to convolute the target data or up-sampled target data to acquire first convoluted data using a first activation function.

21. The decoder of claim 17, further comprising a normalizing element, which is configured to normalize the first data.

22. The decoder of claim 1, wherein the second learnable section is pre-trained with respect to the first learnable section.

23. An encoder for generating a coded signal in which an input audio signal is encoded, the encoder comprising:
a first learnable section comprising at least one learnable layer to provide a first latent representation of the input audio signal,
a scalar quantization module, to quantize the first latent representation, comprising:
a second learnable section to provide, from the first latent representation, a plurality of latent scalar values to be quantized; and
a plurality of quantizers, to provide a plurality of indexes, each quantizer being configured to quantize one single latent scalar value to be quantized and to provide, from the one single latent scalar value, an index of the plurality of indexes; and
a coded signal writer configured to write the plurality of indexes in the coded signal.

24. The encoder of claim 23, wherein each quantizer, or at least one quantizer, is configured to quantize the respective latent scalar value using at least one codebook which is a quantizer-specific codebook.

25. The encoder of claim 23, wherein all, or at least a multiplicity which is a subset of the plurality of quantizers, are configured to quantize the respective latent scalar values using at least one codebook which is a common codebook.

26. The encoder of claim 23, wherein at least one quantizer is a residual or multi-stage quantizer.

27. The encoder of claim 23, wherein at least one codebook is learnable.

28. The encoder of claim 23, wherein at least one codebook has a variable-length bitstream representation.

29. The encoder of claim 28, configured so that, at least for two of the latent scalar values, or for a plurality of the latent scalar values, or for all the latent scalar values, more frequent latent scalar values are mapped onto indexes which are more compact in the coded signal representation than the indexes mapped by less frequent scalar values.

30. The encoder of claim 23, wherein at least one codebook or quantization is non-uniform, where the value range to quantize is divided into unequal intervals, in such a way that more frequent intervals are smaller than less frequent intervals.

31. The encoder of claim 23, configured to select between at least a first encoding mode and a second encoding mode, wherein the first encoding mode is a first, low-quantizers-number, encoding mode and the second encoding mode is a second, high-quantizers-number, encoding mode, the encoder being configured in such a way that, in the first, low-quantizers-number, encoding mode, the plurality of latent scalar values comprises less latent scalar values than in the second, high-quantizers-number, encoding mode, the encoder thereby using less quantizers in the first, low-quantizers-number, encoding mode than in the second, high-quantizers-number, encoding mode.

32. The encoder of claim 23, configured to select between at least one first encoding mode and one second encoding mode, wherein the second encoding mode is a second, high-index-number, encoding mode and the first encoding mode is a first, low-index-number, encoding mode, wherein the encoder is configured, in the second, high-index-number, encoding mode, to use at least one codebook with a higher number of indexes, with higher resolution, and/or with higher code-length, and/or with more quantization levels, and/or with higher index bit-length than in the first, low-index-number, encoding mode.

33. The encoder of claim 23, configured to select between at least one first encoding mode and one second encoding mode, wherein the second encoding mode is a second, expanded-latent, encoding mode, and the first encoding mode is a first, reduced-latent, encoding mode, wherein the second learnable section is configured, in the second encoding mode, to provide more latent scalar values than in the first encoding mode.

34. The encoder of claim 23, configured to select between at least a first encoding mode and a second encoding mode, so that:
in the second encoding mode, there are used the plurality of quantizers to provide the plurality of indexes, each quantizer being configured to quantize one single latent scalar value to provide the one index of the plurality of indexes; and
in the first encoding mode, there is used at least one quantizer to quantize multiple latent scalar values onto one single index.

35. The encoder of claim 23, configured to perform in parallel both a first encoding mode to provide a first coded signal version and a second encoding mode to provide a second coded signal version, and to select between the first encoding mode and the second encoding mode by choosing to write, in the coded signal, the coded signal version, out of the first and the second coded signal versions, which minimizes the distortion with respect to the input audio signal.

36. The encoder of claim 23, configured to select between the first encoding mode and the second encoding mode based on a status of a communication link through which the coded signal is transmitted, so as to select, among the first encoding mode and the second encoding mode:
the encoding mode which provides a higher resolution, but higher bitlength, in case the communication link is comparatively highly performing; and
the encoding mode which provides a lower resolution, but lower bitlength, in case the communication link is comparatively poorly performing.

37. The encoder of claim 23, configured to select between at least one first classification encoding mode and one second classification encoding mode based on a classification of the input audio signal or a processed version thereof, wherein the first classification encoding mode is trained for a first class of the classification and the second classification encoding mode is trained for a second class of the classification.

38. The encoder of claim 37, wherein the first class is an unvoiced class, and the second class is a voiced class, wherein the first classification encoding mode is an un-voiced-oriented mode, and the second classification encoding mode is a voiced-oriented mode.

39. The encoder of claim 23, wherein the first learnable section is configured to reduce the dimension from the first latent representation to the second latent representation.

40. The encoder of claim 23, wherein the first learnable section comprises a format definer configured to define a multi-dimensional audio signal representation of the input audio signal, the multi-dimensional audio signal representation of the input audio signal comprising at least:
a first dimension, so that a plurality of mutually subsequent frames are ordered according to the first dimension; and
a second dimension, so that a plurality of samples of at least one frame are ordered according to the second dimension, to define a plurality of channels,
wherein the multi-dimensional audio signal representation is inputted to the at least one learnable layer of the first learnable section.

41. The encoder of claim 23, wherein the first learnable section is pre-trained with respect to the second learnable section.
